(19) United States
(12) Patent Application Publication
(10) Pub. No.: US 2003/0182621 A1
(43) Pub. Date: Sep. 25, 2003

(54) Websheets

(75) Inventors: Rich Mazza, El Dorado Hills, CA (US); Howard M. Cooper, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(73) Assignee: Intel Corporation, Santa Clara, CA

(21) Appl. No.: 10/104,937

(22) Filed: Mar. 21, 2002

(51) Int. Cl. G06F 17/00

(52) U.S. Cl. 715/504

(57) ABSTRACT

Websheets have been described.

### FIELD OF THE INVENTION

The present invention pertains to information sharing. More particularly, the present invention relates to a method and apparatus for network sharing of information.

### BACKGROUND OF THE INVENTION

Many companies are adopting the use of networks for sharing information. The Internet is one example of such a network. This information may be shared within a company, university, or local group. Additionally, this information may be presented to others on an open basis, such as, for example, a web page.

Current approaches to securely collect, share, and manage information may not allow interactive, asynchronous, real time changes. Often updates are done in non-real time and require that databases be combined. This may be a problem because multiple people may need to update the information in real time. Additionally, changes to a database may require the locking of a record until the locking user updates the record. This may be a problem where interactive, asynchronous, real time changes are occurring.

### BRIEF DESCRIPTION OF THE DRAWINGS

The present invention is illustrated by way of example and not limitation in the figures of the accompanying drawings, in which like references indicate similar elements and in which:

FIG. 1 illustrates a network environment in which the method and apparatus of the present invention may be implemented;

FIG. 2 is a block diagram of a computer system;

FIG. 3 illustrates one embodiment of the present invention in-place editing;

FIG. 4 illustrates another embodiment of the present invention in-place editing;

FIG. 5 illustrates one embodiment of the present invention for creating a websheet;

FIG. 6 illustrates one example of a websheet being used to document customer visits;

FIG. 7A and FIG. 7B both illustrate a hyperlink data type in action;

FIG. 8 illustrates one embodiment of the present invention with a file upload dialog;

FIG. 9 illustrates one example of one embodiment of the present invention as a websheet being used to document calendar information for persons on vacation;

FIG. 10A and FIG. 10B illustrate a hide duplicates of the present invention;

FIG. 11 illustrates one embodiment of the present invention where a list box is illustrated;

FIG. 12 illustrates one embodiment of the present invention where auto-incrementing and column sort is illustrated;

FIG. 13 illustrates one embodiment of the present invention where a cell history is illustrated;

FIG. 14 illustrates one embodiment of the present invention where background colors may be changed is illustrated;

FIG. 15 illustrates one embodiment of the present invention where a websheet selector is illustrated;

FIG. 16 illustrates one embodiment of the present invention where a help menu is illustrated;

FIG. 17 illustrates one embodiment of the present invention where the Help With Websheets in FIG. 16 has been selected;

FIG. 18 illustrates one embodiment of the present invention where a data entry page is illustrated;

FIG. 19 illustrates one embodiment of the present invention for setting up the websheet as illustrated in FIG. 18;

FIG. 20 illustrates one embodiment of the present invention where a background color selection is illustrated;

FIG. 21 illustrates one embodiment of the present invention where a data type selection is illustrated;

FIG. 22 illustrates one embodiment of the present invention where a default type selection is illustrated;

FIG. 23 illustrates one embodiment of the present invention where a pick list page definition is illustrated;

FIG. 24 is illustrates one embodiment of the present invention where the pick list was as defined in FIG. 23;

FIG. 25 illustrates one embodiment of the present invention where a security entry page is illustrated;

FIG. 26 illustrates one embodiment of the present invention where a dialog box is illustrated;

FIG. 27 illustrates one embodiment of the present invention where the editing of a websheet's properties is illustrated;

FIG. 28, FIG. 29, and FIG. 30 all illustrate various of the present invention where the websheet has calendar functions;

FIG. 31 illustrates an embodiment of the present invention where a row has been selected during data entry;

FIG. 32 illustrates an embodiment of the present invention where a column has been selected during data entry;

FIG. 33 illustrates an embodiment of the present invention where the user has selected Filter;

FIG. 34 illustrates an embodiment of the present invention where the user has selected to enter filter criteria;

FIG. 35 illustrates an embodiment of the present invention where a pull down filter condition box is shown;

FIG. 36 illustrates an embodiment of the present invention where the user has selected to view other websheets of interest;

FIG. 37 illustrates an embodiment of the present invention where the user has selected to view and choose a font;

FIG. 38 illustrates an embodiment of the present invention where the user has selected to view and choose a font size;

FIG. 39 illustrates an embodiment of the present invention where the user has selected to view the last ten websheets visited;

FIG. 40 illustrates an embodiment of the present invention where the user has selected to view the This WebSheet's URL;

FIG. 41 illustrates an embodiment of the present invention where the user has selected the WebSheet option;

FIG. 42 illustrates an embodiment of the present invention where the user has selected Search on the menu bar;

FIG. 43 illustrates one embodiment of the present invention where a websheet selector is illustrated with hidden sheets;

FIG. 44 illustrates one embodiment of the present invention where emailing is illustrated;

FIG. 45 illustrates one embodiment of the present invention where automatic emailing is illustrated; and

FIG. 46 illustrates one embodiment of the present invention where emailing for a denied websheet is illustrated.

### DETAILED DESCRIPTION

A method and apparatus for network sharing of information are described.

The present invention by providing a mini web application containing a database allows a simple database, in the style of a spreadsheet, which allows sharing of information. The embodiment of the present invention is called a websheet or websheets and allows for users to securely collect, share, and manage information interactively, asynchronously, and in real time.

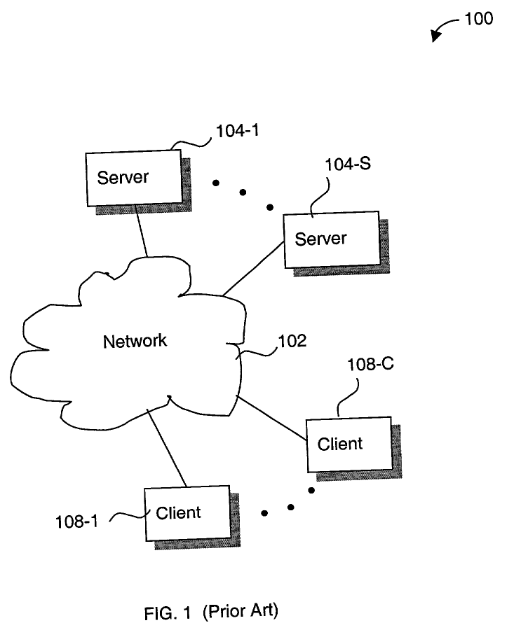

FIG. 1 illustrates a network environment 100 in which the techniques described may be applied. The network environment 100 has a network 102 that connects S servers 104-1 through 104-S, and C clients 108-1 through 108-C. More details are described below.

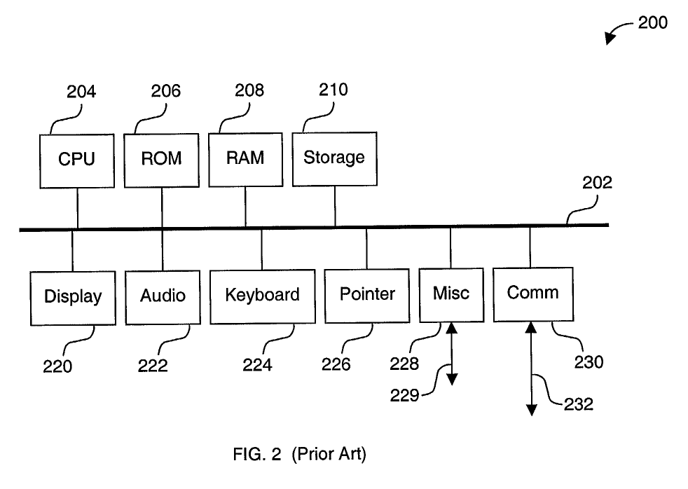

FIG. 2 illustrates a computer system 200 in block diagram form, which may be representative of any of the clients and/or servers shown in FIG. 1. More details are described below.

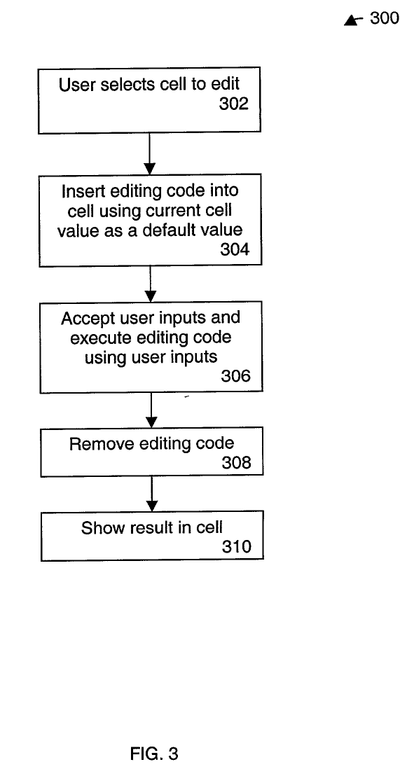

FIG. 3 illustrates one embodiment of the present invention in-place editing 300. The user selects a cell to edit 302. Editing code is then inserted into the cell using any current value in the cell as a default value 304. For example, if the cell contained a date, then for example, code would be inserted into the cell with the date as the default value. Another example, may be where the cell contains text or numbers. The current text or number value would be used as a default value for the code inserted into the cell. If the cell has no entry, then for example, a null or coded default value may be used. At 306 user input is accepted and the editing code is executed using the user inputs generating a result. At 308 the editing code is removed. At 310 the result of the executed editing code using the user inputs at 306 is then shown in the cell.

For example, if the cell has date type data, then clicking on the cell may inset editing code that brings up a calendar with the current cell date indicated as a default value. The user may then, for example, click on another date indicating a user input, and the editing code would operate based on this user input. The editing code would be removed and shown in the cell would be the new date as selected by the user input.

Yet another example, may be text in a cell. The editing code may open a text box in which the user may type new text. The new text would be displayed in the cell after the editing code had been removed from the cell.

It should be noted that the code inserted into the cell may be executed locally on a client and/or on a server. It is also possible that the editing operation may involve other computers on a network. For example, if the cell contains a file entry, then the editing code operation to, for example, browse to find another file to insert into the cell may be executed by the client, and yet after the selection of the file is made it may involve transferring the file from another computer located on a network.

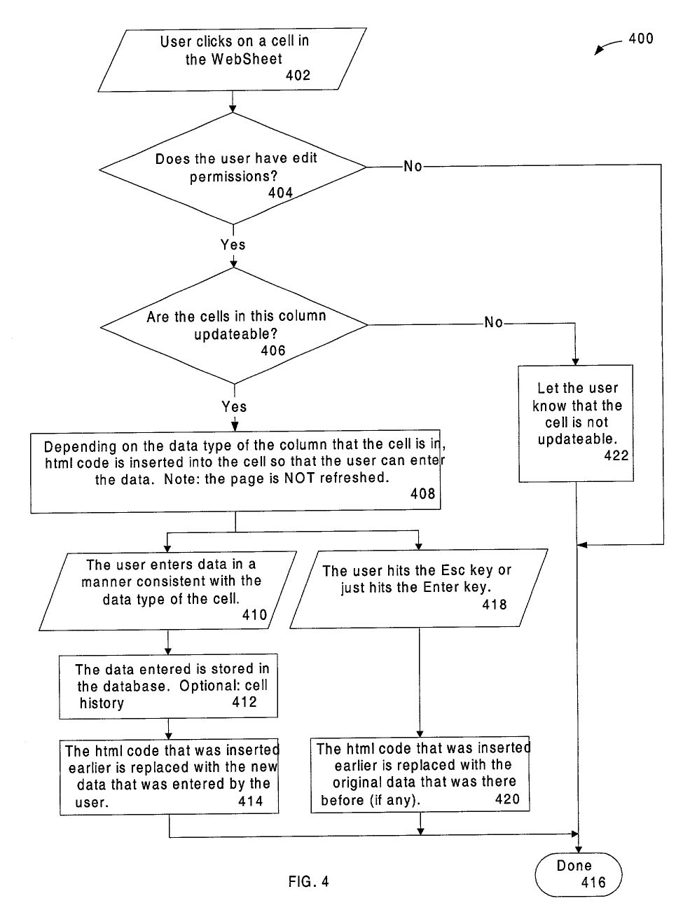

FIG. 4 illustrates another embodiment of the present invention in-place editing 400. At 402 the user clicks on a cell in the websheet to indicate the desire to edit the cell contents. At 404 a check is made to see if the user has edit permissions. If the user does not have edit permissions then editing may not be done by that user and the user is done 416. If the user does have edit permissions, then a check is made at 406 to determine if the cell selected (at 402) is in a column where the cells are updateable. If the cell selected (at 402) is in a column where cells are not updateable, then at 422 the user is informed that the cell is not updateable, and the user is done 416. If the cell selected by the user (at 402) is updateable, then HTML code is inserted into the cell based upon the type of data in the cell 408. Note that the page on which the cell is located does not need to be refreshed, as for example, a standard HTML table would need.

The type of code inserted into the cell 408, as mentioned previously, varies based upon the cell contents. For example, code to edit a date may be different than code for editing a number. After the editing code is inserted into the cell, the user may decide to enter data (410, 412, 414 path) or may decide to not enter data (418, 420 path). If the user decides not to enter data, as may be indicated by the user hitting an ESC (Escape) key or hitting the Enter key 418, then the HTML code that was inserted earlier (at 408) is removed and any original data that was in the cell, if any, is put back into the cell 420, and then the user is done 416. For example, if the cell contained pricing information and the user selected the cell for editing, the user had permissions to edit the cell, the cell was updateable, and then the user decided not the update the information and so indicated by pressing the ESC key, then the original pricing information would still be in the cell.

If the user decides to enter data, then the user inputted data is accepted if it is consistent with the data type in the cell 410. The new data is stored in a database 412. Optionally, at 412 the history of a cell may also be stored. For example, the older cell values may be stored for easy viewing and may be, for example, easily retrievable. After the data is entered (at 412) the HTML code that was inserted earlier (at 408) is removed and the new data entered by the user (at 412) is placed in the cell, then the user is done 416.

An assemblage of cells into a grid format having rows and columns is more easily denoted by the use of the word websheet, websheets, or some variation thereof. A websheet may also have associated with it other information, formats, and/or graphical user interfaces as well. For example, a websheet may have a panel for displaying help or instructions. Note however, that a websheet has cells that may be edited in-place without opening an external editor or another application. That is, the editing may be performed by selecting the cell and having code inserted based upon the cell properties and/or position.

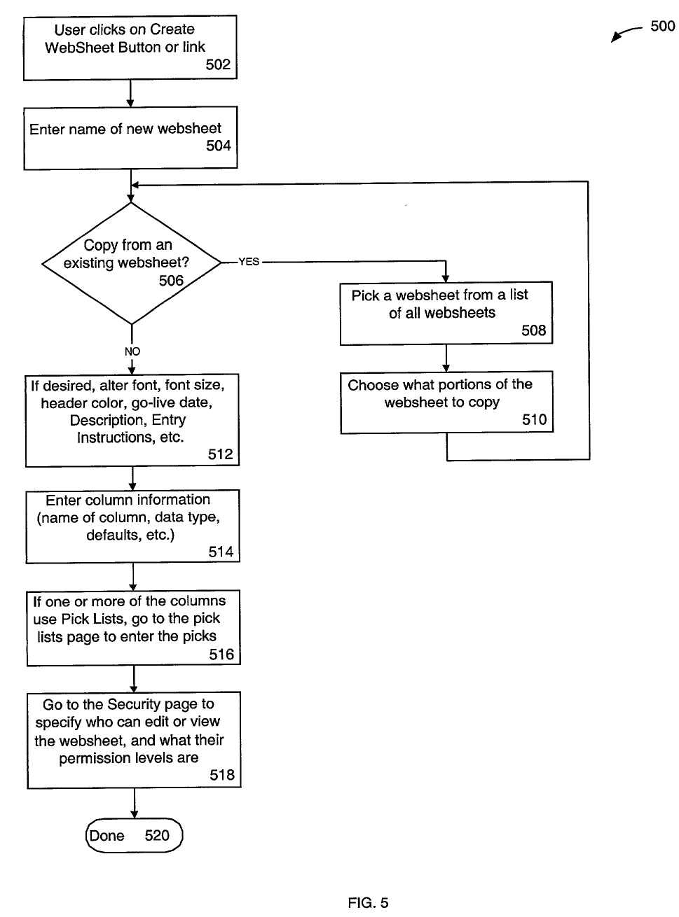

FIG. 5 illustrates one embodiment of the present invention for creating a websheet 500. At 502 a user clicks on a create websheet button or link. The user then enters the name of the new websheet 504. A check is then made toe see if the user wants to copy components and/or values from an existing websheet 506. If the user decides not to copy from an existing websheet then the user proceeds to 512. If the user decides to copy parts or an entire websheet, then at 508 they pick from a list of websheets the one they want to copy from 508. After choosing the websheet (at 508), the user may copy what portions of that websheet that they want 510. Then the user proceeds back to checking to see if they want to copy from an existing websheet 506. In this way, the user may select to copy from more than one websheet if they want. At 512 the user may define and alter properties, information, actions, etc. of the websheet. For example, the user may alter font, font size, header color, a go-live date, description, entry instructions, etc. 512.

At 514 the user may enter column information such as, but not limited to, name of the column, data type, default values, etc. Then at 516, if one or more of the columns allow the use of pick list, then the user may go and enter the various picks allowed. At 518, the user may define security associated with the websheet. For example, the user may define who may edit, or view the websheet and set their permission levels. For example, the user who creates a websheet for tracking contact information may only want the account managers to be able to edit the contact information while allowing all sales people to view the contact information. After setting any security permissions (at 518) the user is done 520.

What follows is a more detailed possible embodiment of the present invention. Many screen shots are used to illustrate possible features and capabilities of the present invention. However, it is to be understood that this is one embodiment of the present invention and that many others are possible.

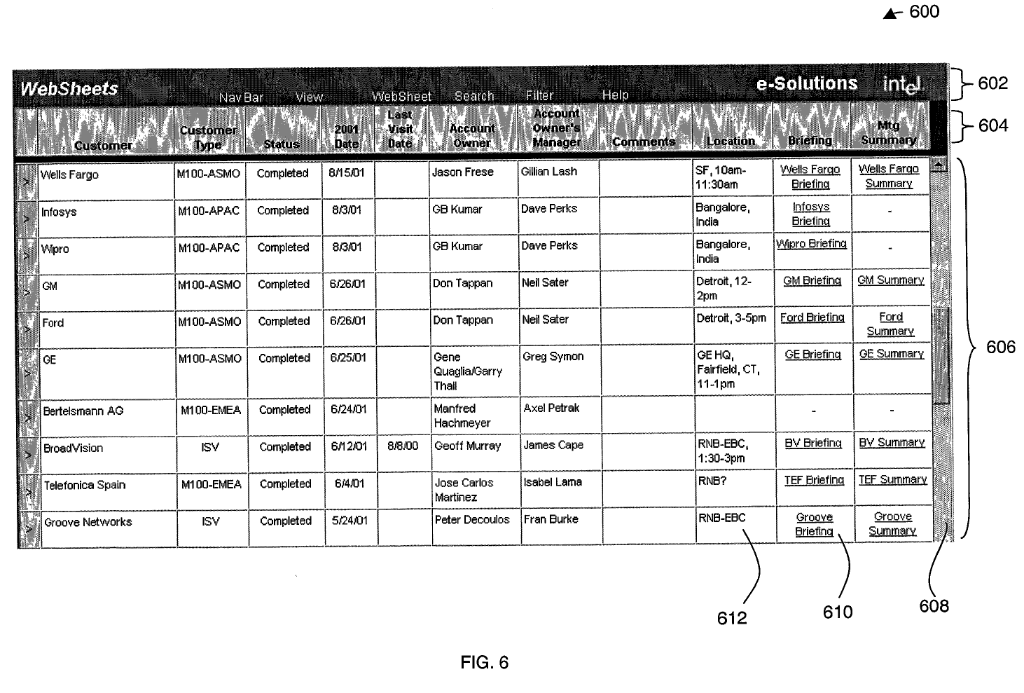

FIG. 6 illustrates one example of a websheet 600 being used to document customer visits. At 602 is a region indicating options that may be available. For example, in this screen shot, the following options are listed: NavBar, View, Websheet, Search, Filter, and Help. At 604 is another region detailing what the columns denote. In this screen shot going from left the right, the columns denote: Customer, Customer Type, Status, 2001 Date, Last Visit Date, Account Owner, Account Owner's Manager, Comments, Location, Briefing, and Mtg Summary. Rows 606 of such columnar information may be larger than a single screen may display and so a scroll bar capability 608 is present. Information in the cells which are the intersection of a column and a row, may be in various forms. Here at 612 a text entry is shown. At 610 a text entry which has a link to other information is shown. The link may be, for example, a hyperlink, a bookmark link, etc.

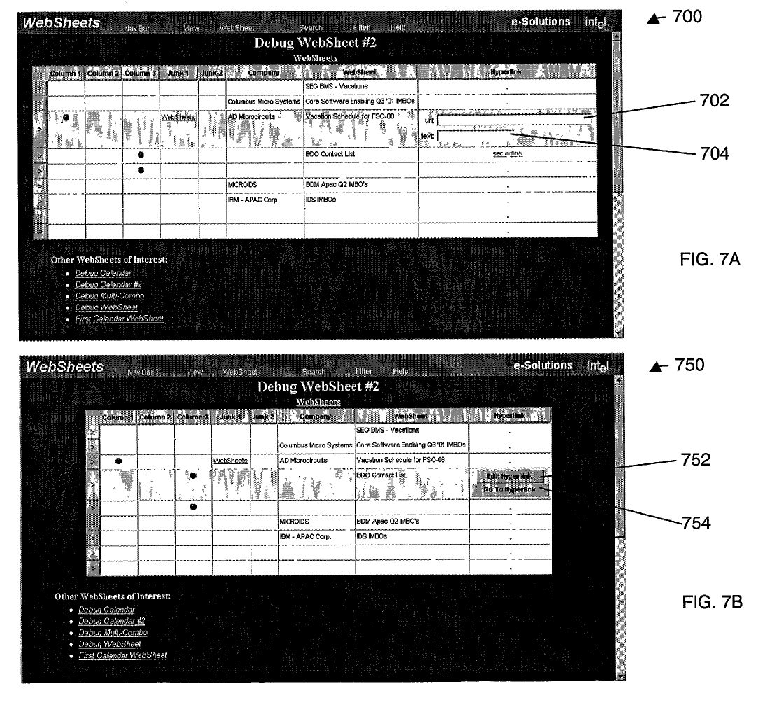

FIG. 7A and FIG. 7B both illustrate a hyperlink data type in action. FIG. 7A illustrates a screen shot 700 when a user with edit permissions clicks on a cell in a hyperlink column when nothing was previously in the cell. At 702 the user may enter a URL and at 704 the user may enter associated text for the URL at 702 which is to be displayed in the cell. FIG. 7B illustrates a screen shot 750 when a user with edit permissions clicks on a cell in a hyperlink column when something was previously in the cell. Here, the user is presented with two options. The first option at 752 is to edit the hyperlink. This option would be much like the display 700, however, the entries 702 and 704 may have the current cell values. The second option 754 is to go to the site pointed to by the hyperlink.

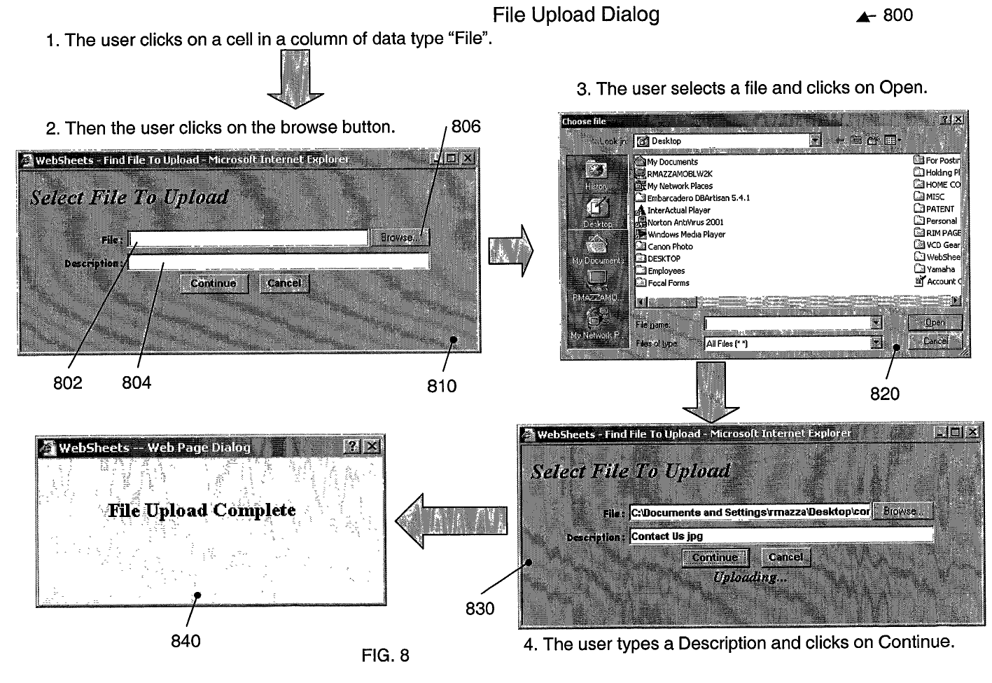

FIG. 8 illustrates one embodiment of the present invention 800 with a file upload dialog. To start the file upload dialog, a user may click on a cell in a column which has a data type of “file.” This brings up a window 810 which has a place for the filename 802, a place for a description of the file 804. Additionally, the window 810 has a browse button 806 that may be used to select a file. If the user selects the browse button 806 than a file selection window 820 opens. In the file selection window 820 the user may navigate, select the file, and then press the Open button. After this, window 830 appears indicating the file to be uploaded as well as a place for the user to enter a description. Buttons allow the user to browse, cancel, or continue. If the user selected to continue, then after the file upload is completed, a window 840 appears indicating the file upload is complete.

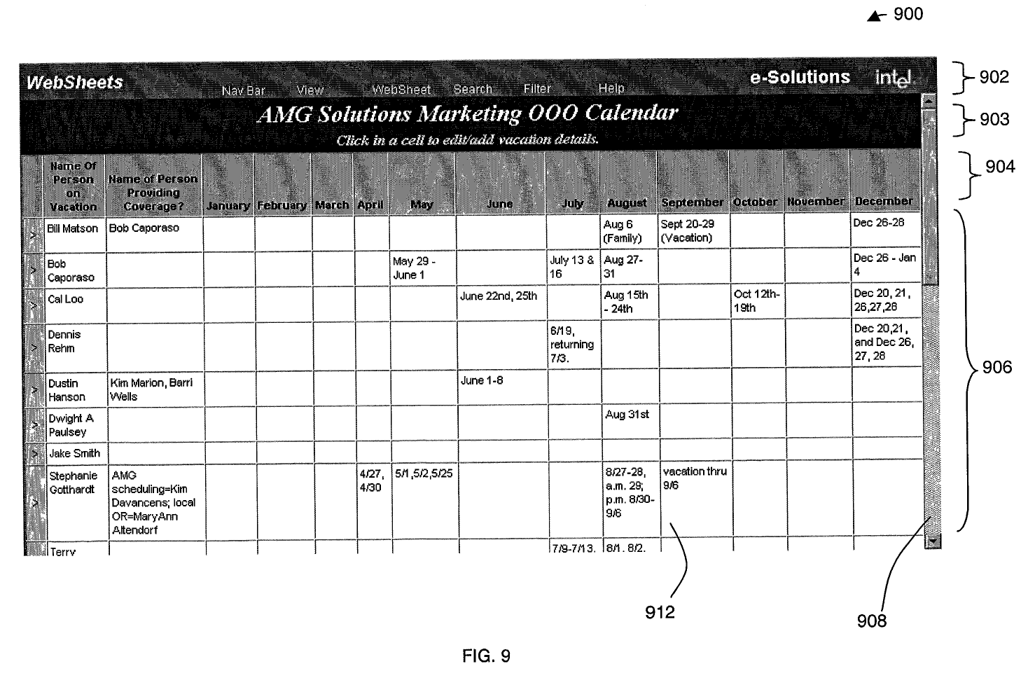

FIG. 9 illustrates one example of one embodiment of the present invention as a websheet 900 being used to document calendar information for persons on vacation. At 902 is a region indicating options that may be available. For example, in this screen shot, the following options are listed: NavBar, View, Websheet, Search, Filter, and Help. At 903 is a title indicating who's calendar it is and the additional information that a user may click to edit/add vacation details. At 604 is another region detailing what the columns denote. In this screen shot going from left the right, the columns denote: Name of Person on Vacation, Name of Person Providing Coverage, and then the months listed. Rows 906 of such columnar information may be larger than a single screen may display and so a scroll bar capability 908 is present. Information in the cells, which are the intersection of a column and a row, may be in various forms. Here at 912 a text entry with a date is shown.

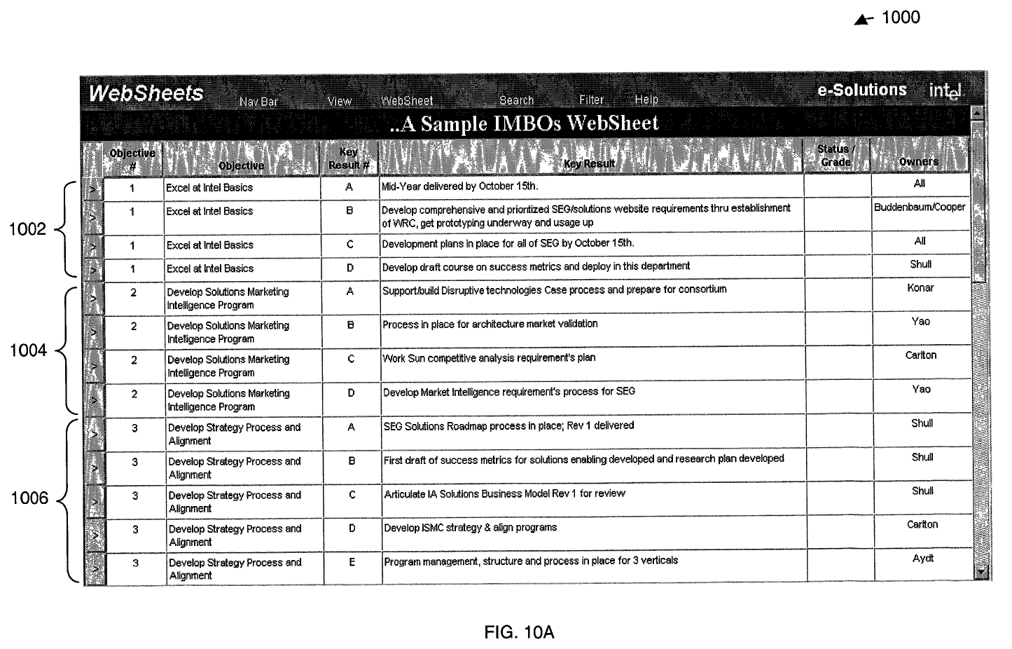

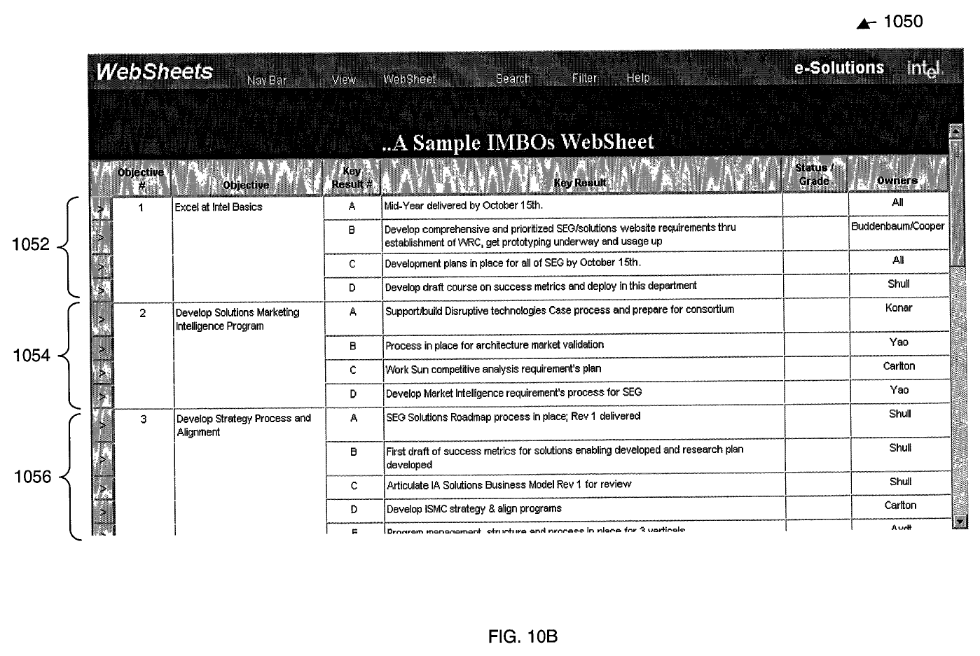

FIG. 10A and FIG. 10B illustrate a hide duplicates embodiment (1000 and 1050) of the present invention. In FIG. 10A at rows 1002, 1004, and 1006, there is duplicated information in columns labeled, Objective #, and Objective. This duplicated information may make the reading of this websheet difficult. By setting a hide duplicates parameter to “yes” the display in FIG. 10B may be obtained. Note that at rows 1052, 1054, and 1056, that the duplicate information in the columns labeled, Objective #, and Objective has been hidden. This may improve readability. Also to note is that the horizontal row lines now only start where differing information is displayed, that is the horizontal lines start only at the column Objective #, or Key Result #. This also may improve readability.

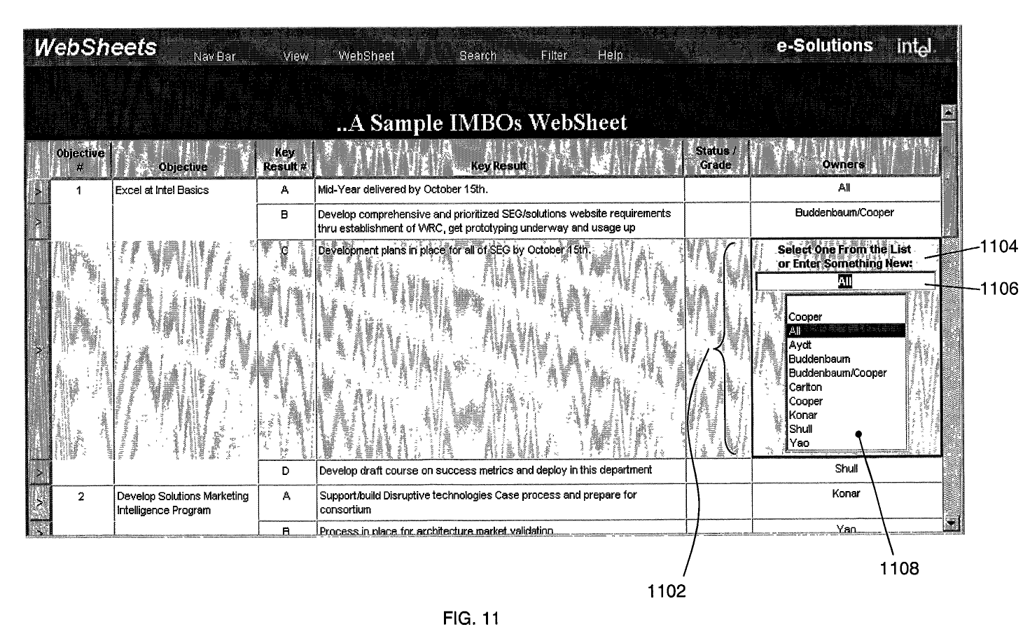

FIG. 11 illustrates one embodiment 1100 of the present invention where a list box is illustrated. Here, a user has selected a cell in the Owners column. As a result a list box 1102 has opened. The list box 1102 has instructions 1104, an entry area 1106, and scroll selection 1108. This list box 1102 allows the user to either select existing entries 1108 or enter new information 1106. New information entered into 1106 may become an entry in the selection 1108.

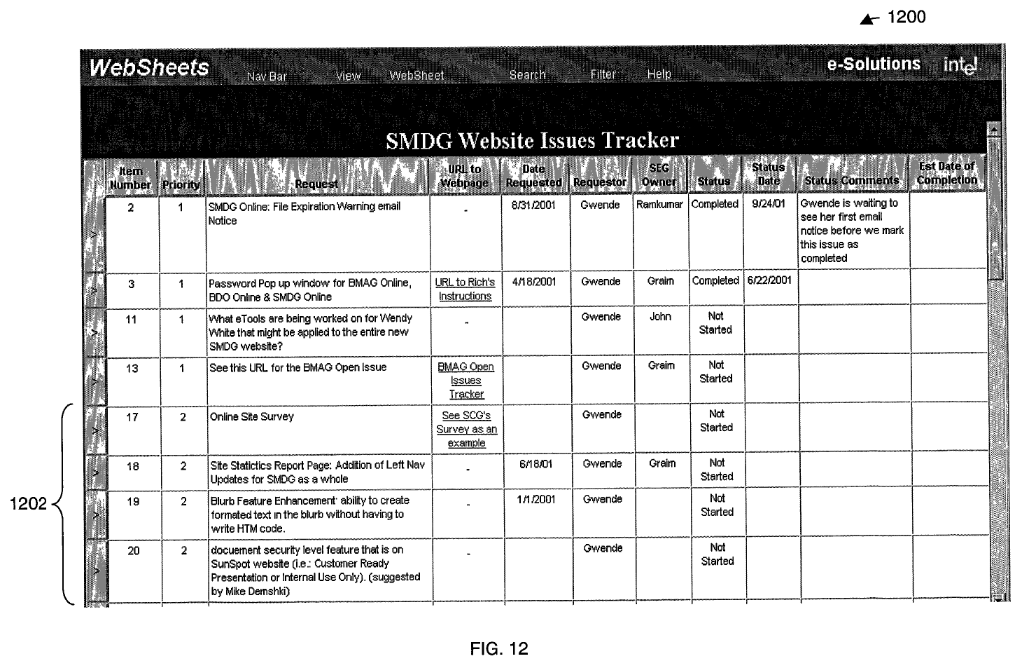

FIG. 12 illustrates one embodiment 1200 of the present invention where auto-incrementing and column sort is illustrated. Auto-incrementing a column is a field attribute that may be set. Here, at rows 1202 in the Item Number column may be seen the incrementing sequence from 17-20. There is also the capability to sort on data in a column. Here, column titled “Priority” has been sorted on. As a result, the item numbers are not in a contiguous order after the sort because there were different priority numbers assigned. The column titled “URL to Webpage” illustrate the use of hyperlinks to other information. Additionally, as previously illustrated, file uploads are also supported.

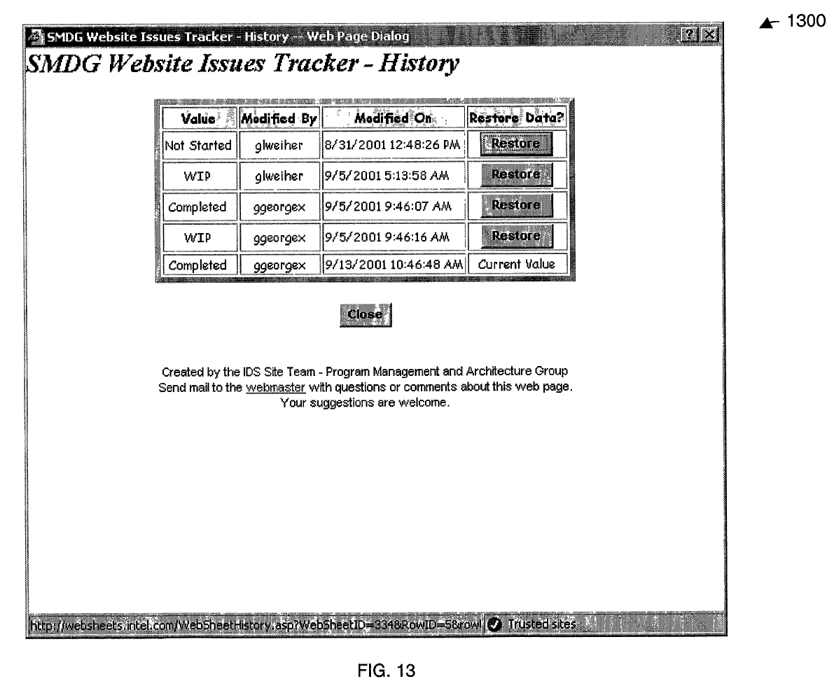

FIG. 13 illustrates one embodiment 1300 of the present invention where a cell history is illustrated. A user may select a cell and then view the cell history. For example, in one embodiment of the present invention, a user selects a cell and then presses F2 on a keyboard to view the cell history. In FIG. 13, the matrix of information has columns denoting Value, Modified By, Modified On, and Restore Data?. The current value in illustrated here as in bottom row. Restoring previous information is done by clicking on the Restore button in the associated row. This full history feature, allows a user to determing what previous value was in the cell, who entered it, and when it was entered. The Resotre button in the Restore Data? column allows for easy entry of an earlier value.

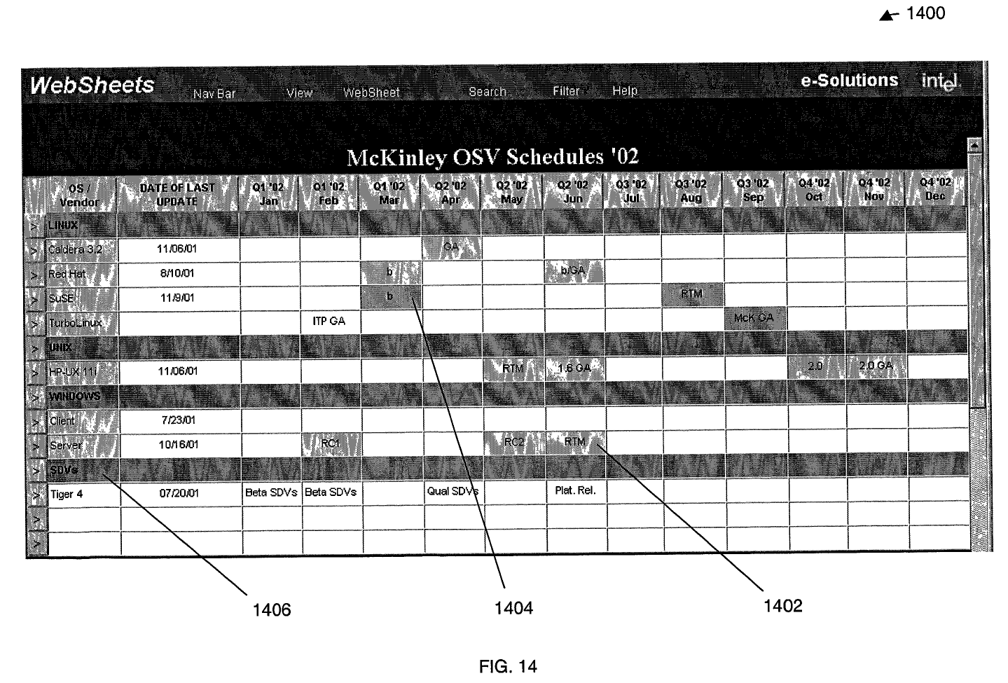

FIG. 14 illustrates one embodiment 1400 of the present invention where background colors may be changed is illustrated. Here, the shade at 1402 represents a cell background color of yellow. The shade at 1404 represents a cell background color of purple, and the shade at 1406 represents a light blue. Also to note is that individual cells may be differing colors, even if in the same column, as well as entire rows and/or columns may be assigned background colors. One of ordinary skill in the art will appreciate that colors may be useful in conveying information and my be based upon the cell contents. For example, in accounting a black cell may indicate a profit whereas a red cell may indicate a loss.

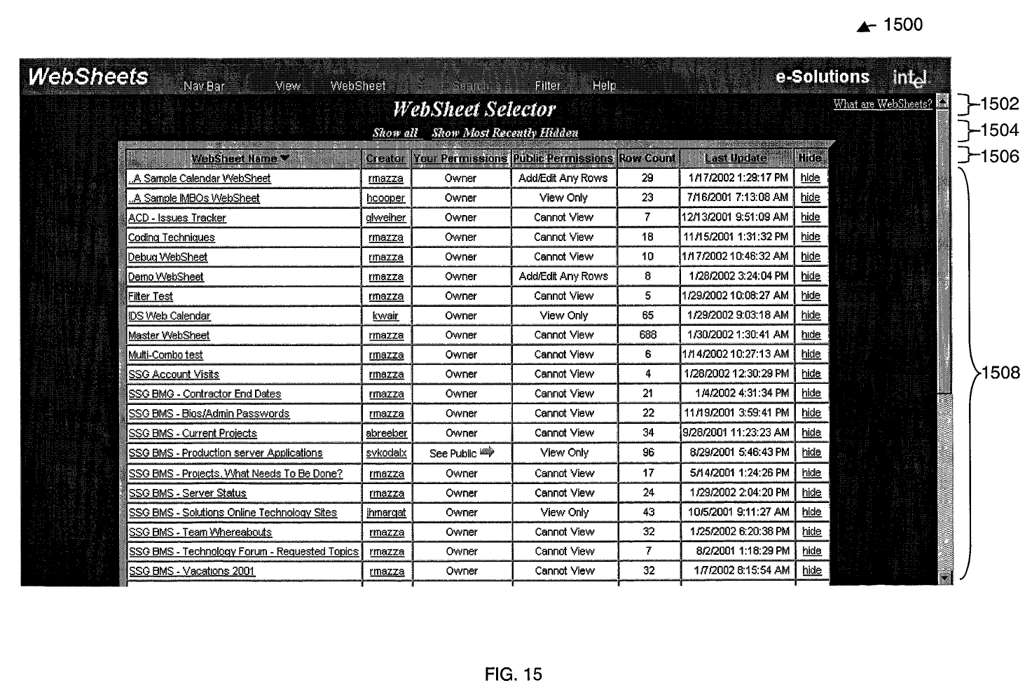

FIG. 15 illustrates one embodiment 1500 of the present invention where a websheet selector is illustrated. At 1502 in the center of the sheet is the title WebSheet Selector. Rows at 1508 show some of the various websheets, and columns at 1506 denote the WebSheet Name, Creator, Your Permission, Public Permission, Row Count, Last Update, and Hide. At 1504 are several options for viewing websheets in existence, they are Show all, and Show Most Recently Hidden. Assume for purposes of illustration that the user's name is rmazza. When rmazza views this page, he is shown as the Owner of several of the websheets and has as a result Owner permissions under the column Your Permissions. Note that the owner may also set the Public Permissions. For some websheets, if the owner does not want the public to view the websheet, that the Public Permission may be set to Cannot View. Creator svkodaix has created a websheet where user rmazza's permission (under Your Permission) indicates to “See Public→”, which indicates that rmazza may only view that websheet. Column Hide allows the user by clicking on the respective hide link in any row to hide that websheet from the WebSheet Selector view. To unhide, the selections at 1504 may be used.

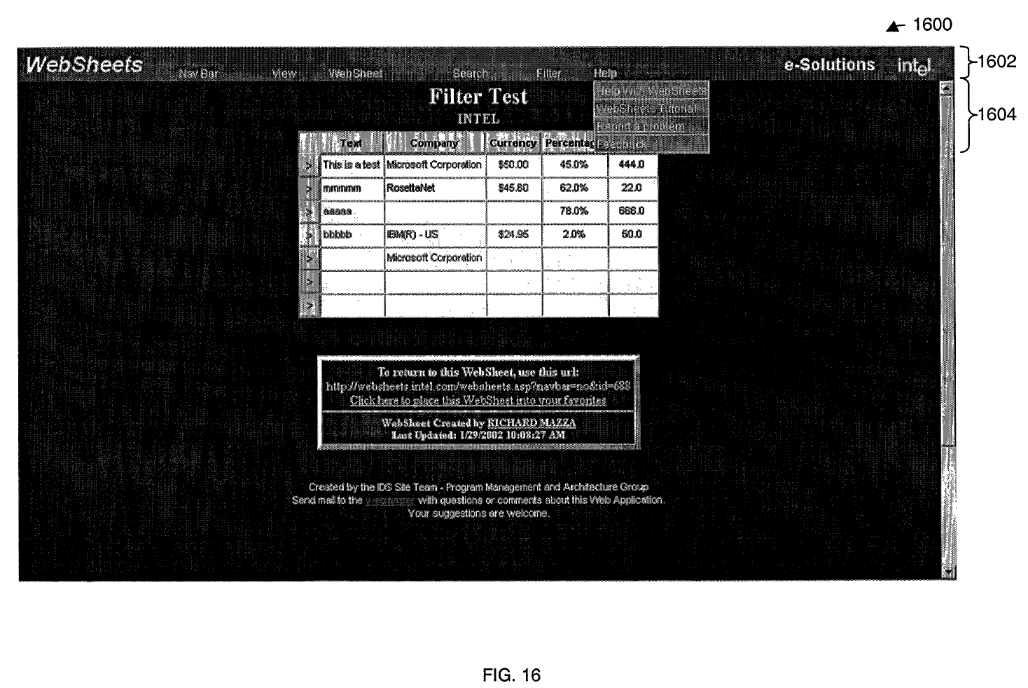

FIG. 16 illustrates one embodiment 1600 of the present invention where a help menu is illustrated. At 1602 is located a Help link. When this link is selected, a selection 1604 is presented. The user by selecting one of the options at 1604 may obtain help, view a tutorial, report a problem, and provide feedback to the creator.

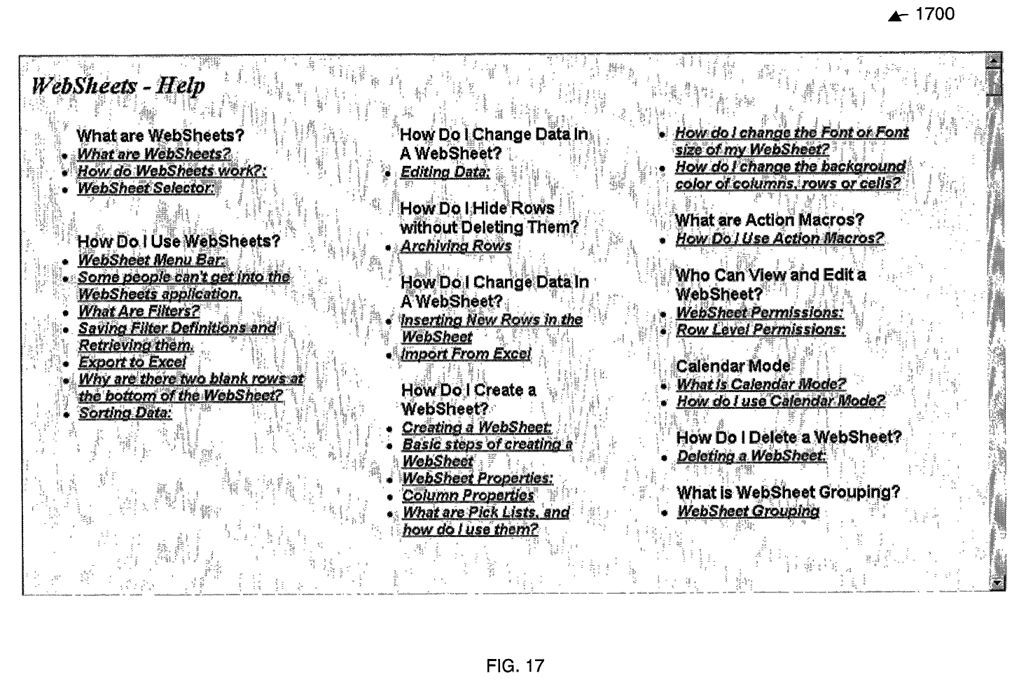

FIG. 17 illustrates one embodiment 1700 of the present invention where the Help With Websheets in FIG. 16 has been selected. FIG. 17 illustrates an opening page for help where links to various subjects are displayed. Clicking on any of the underlined links will take the user to more information on the clicked subject.

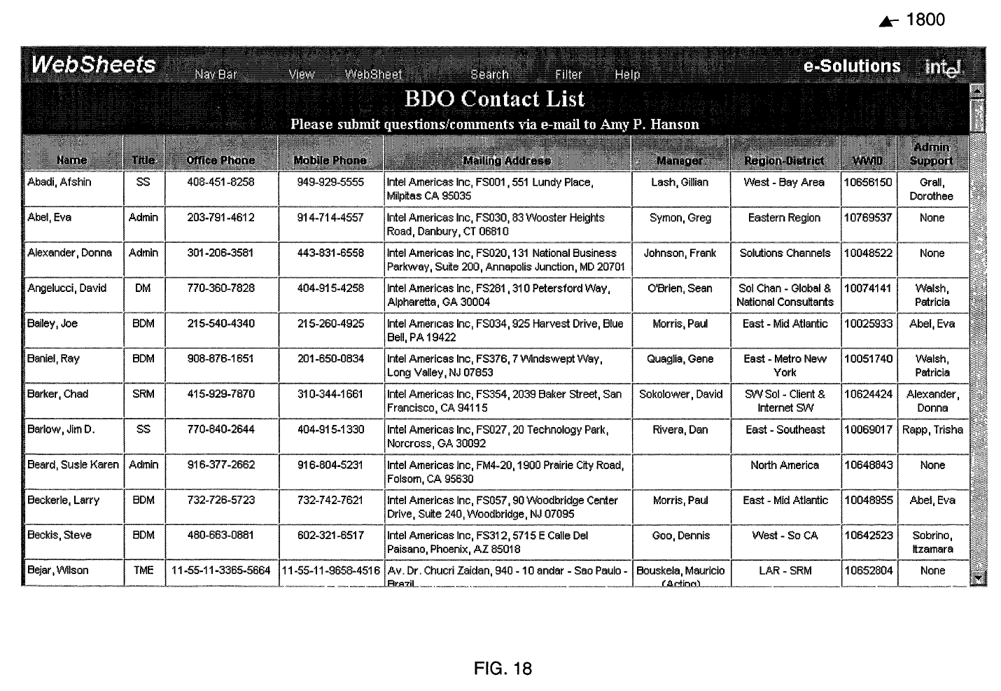

FIG. 18 illustrates one embodiment 1800 of the present invention where a data entry page is illustrated. This page is the result of data being entered into the various cells. How the rows and columns and cells are set up is itself another websheet.

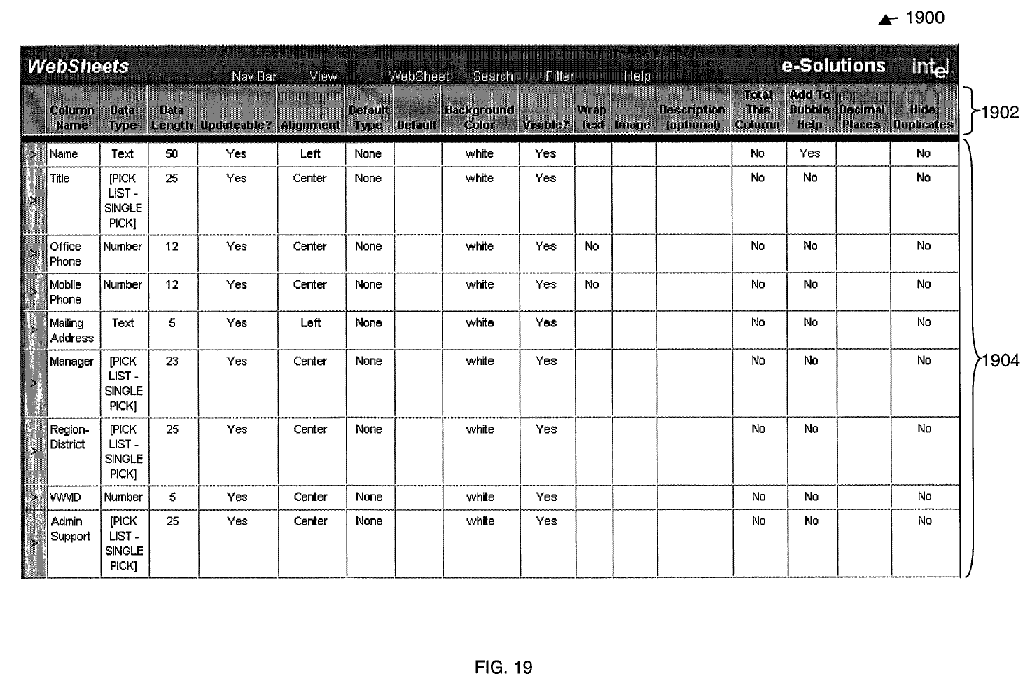

FIG. 19 illustrates one embodiment 1900 of the present invention for setting up the websheet as illustrated in FIG. 18. Here, in FIG. 19, at 1904 (in rows) are defined what are the columns in FIG. 18. Each of the columns in FIG. 18 are represented as rows in FIG. 19 with associated attributes as defined at 1902 in the columns. For example, The leftmost column at 1902 indicates that Column Name is an attribute. Under Column Name are all the columns as they appear in FIG. 18. Each column defined has attributes at 1902. For example, each Column Name has associated with it a Data Type, Data Length, Updateable?, Alignment, Default Type, Default, Background Color, Visible?, Wrap Text, Image, Description (optional), Total This Column, Add to Bubble Help, Decimal Places, and Hide Duplicates.

Each of these attributes affect how the websheet behaves and/or is displayed. For example, referring back to FIG. 10A where duplicate entries were displayed in column Objective #, and column Objective, now looking at FIG. 19, one would appreciate that these columns (Objective # and Objective) when originally defined had the Hide Duplicates at 1902 set to No. Likewise, in FIG. 10B where the duplicates for columns Objective # and Objective were not displayed, when they were defined the the Hide Duplicates at 1902 was set to Yes for these columns.

As may be seen in FIG. 19, each attribute may have varying types and/or allowable values. For example, the Data Type column illustrates that for the Column Name entry of Mailing Address that only a Data Type of Text will be allowed. Mobile Phone is a Number, and Title will make use of a picklist where only a single pick is allowed.

The length of the data allowed is defined in Data Length. Whether the data is updateable is defined as Yes or No in the Updateable? field. Alignment of the data may be left, centered, or right. The data may have a Default Type either None or the data type, and a default value may be entered for each in the Default field. A Background Color may be chosen for the respective column. Whether the column is visible is defined in Visible? as a Yes or No. Text wrapping is defined in Wrap Text as Yes or No. Image allows for a graphic to be used and may be, for example, a toggle or pick one entry, showing for example a thumbs up, a thumbs down, or other entries. Links may be placed to the graphic in the Image column. Description (optional) is text that will be displayed at the bottom of a screen for assistance. Total This Column allows for a user to have a column totaled. Add To Bubble Help is a help option when a pointer, such as a mouse pointer, hovers over an item. The Add To Bubble Help options are Yes or No. The number of Decimal Places for the data in a column is defined here. Hide Duplicates allows a column to hide (Yes) or display (No) duplicates.

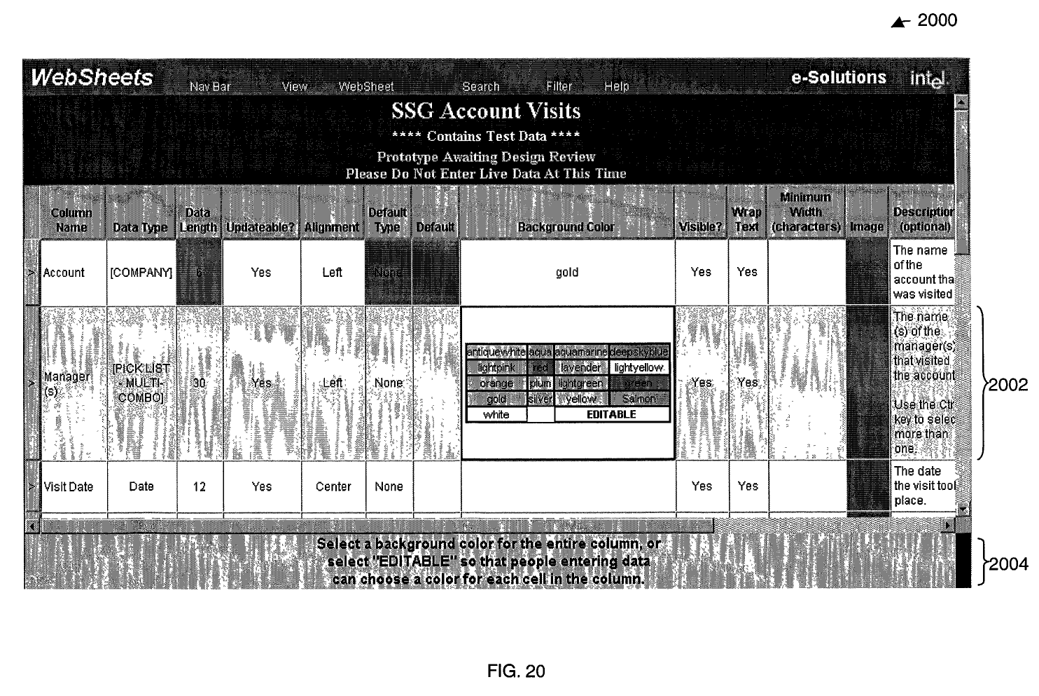

FIG. 20 illustrates one embodiment 2000 of the present invention where a background color selection is illustrated. At 2002 a user has clicked on the Background Color for Manager(s) and is presented with a box showing the various choices. At 2004 is help information. As can be seen the user may select the background color or an entire column or allow the user entering data to choose the color.

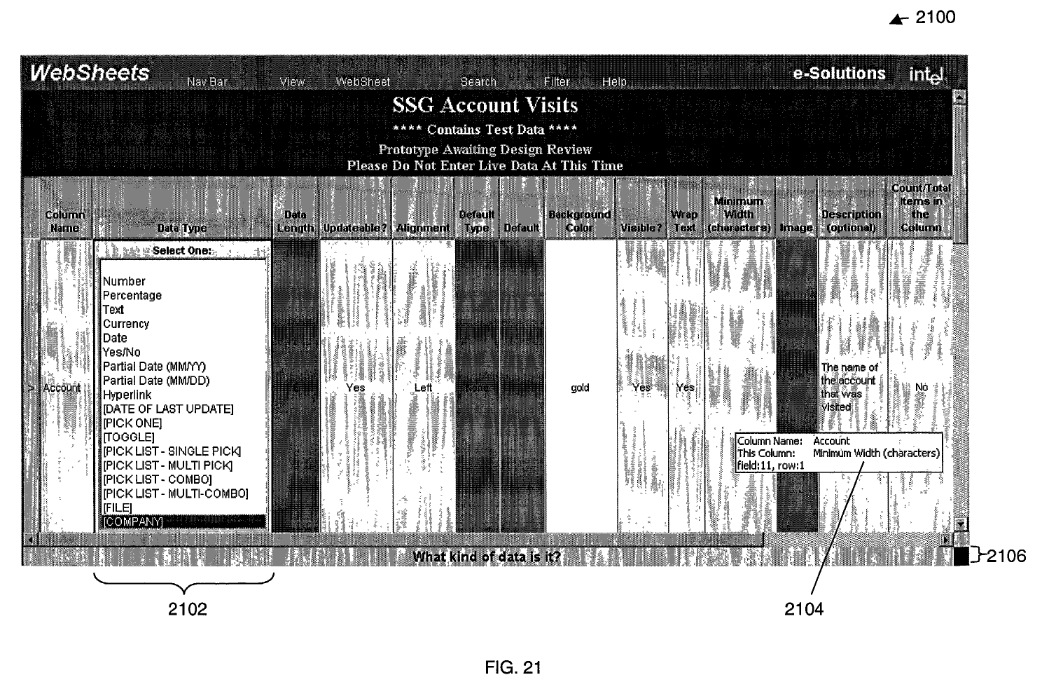

FIG. 21 illustrates one embodiment 2100 of the present invention where a data type selection is illustrated. At 2102 a user has clicked on the Data Type for Account and is presented with a box showing the various choices. At 2104 is a box indicating information about the selected column. At 2106 is help information. As can be seen the user may select from a wide variety of data types, including number, hyperlink, pick lists, file, etc. For example, in FIG. 19 the Admin Support Column Name has been defined as a [Pick List Single Pick].

One of ordinary skill in the art will appreciate that the data entry pages that define a websheet may themselves be defined by websheets. Thus, the help text at 2106 in FIG. 21 is of the type defined in the Description (optional) column in FIG. 19. Also, in FIG. 21, the information at 2104 is of the type as defined in FIG. 19 under Add To Bubble Help.

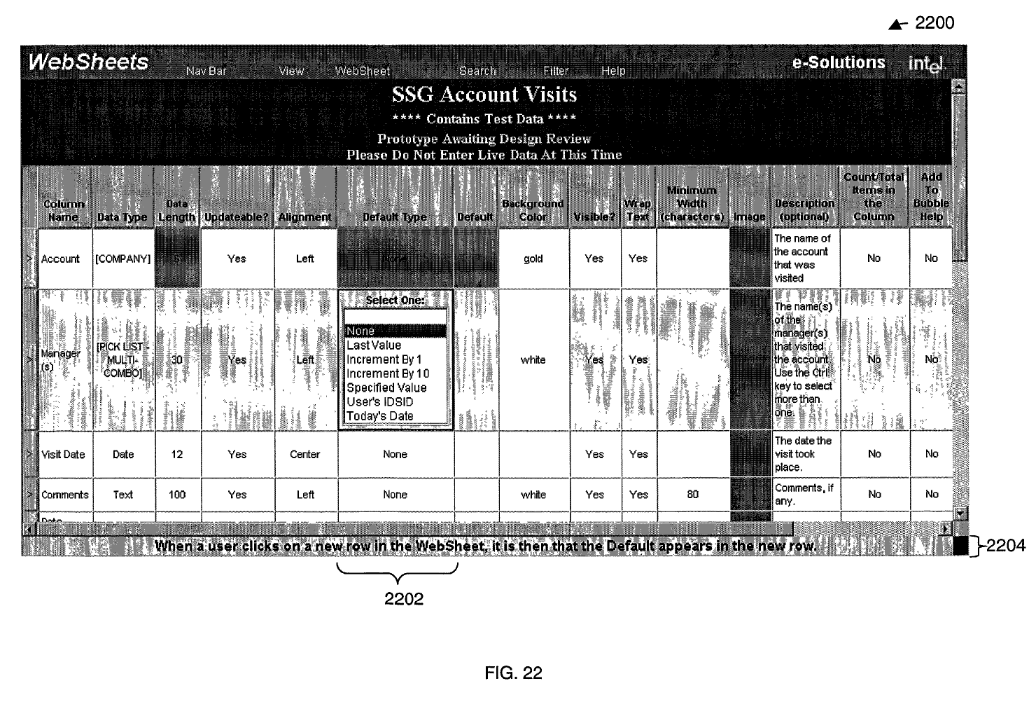

FIG. 22 illustrates one embodiment 2200 of the present invention where a default type selection is illustrated. At 2202 a user has clicked on the Default Type for Manager(s) and is presented with a box titled “Select One:” showing the various choices. At 2204 is a box indicating information about the selected column, showing here that when a user of the designed websheet clicks on a new row, that is when the default appears. As seen at 2202 there are a variety of default types, including none, increment by 10, a user's identification, today's date, etc.

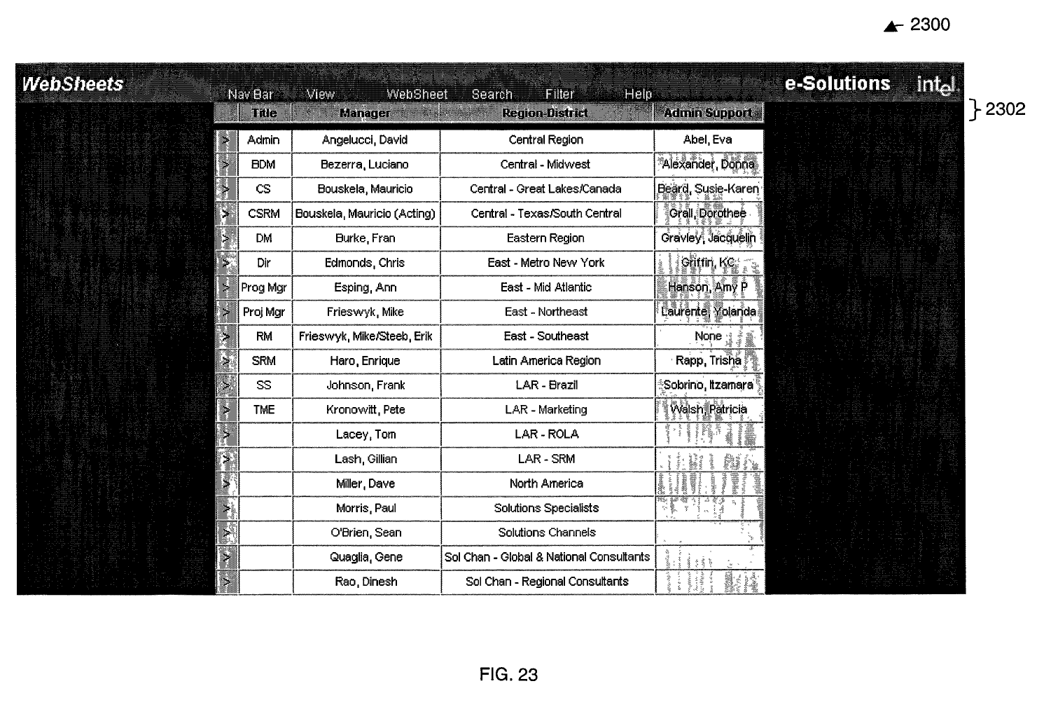

Just as the columns in a websheet are defined by another data entry page with entries, so too may the entries in a pick list be defined by another pick lists page. FIG. 23 illustrates one embodiment 2300 of the present invention where a pick list page definition is illustrated. Here, at 2302 are the various attributes for a pick list entry. For example, in the leftmost column the pick list entry has a Title. Under, for example, Dir there is a Manager Edmonds, Chris. Under Region-District is East 0 Metro New York, and under Admin Support is Griffin, KC. Thus, in each column of the picks list page, the creator of a websheet may enter the picks that will be available to people entering data.

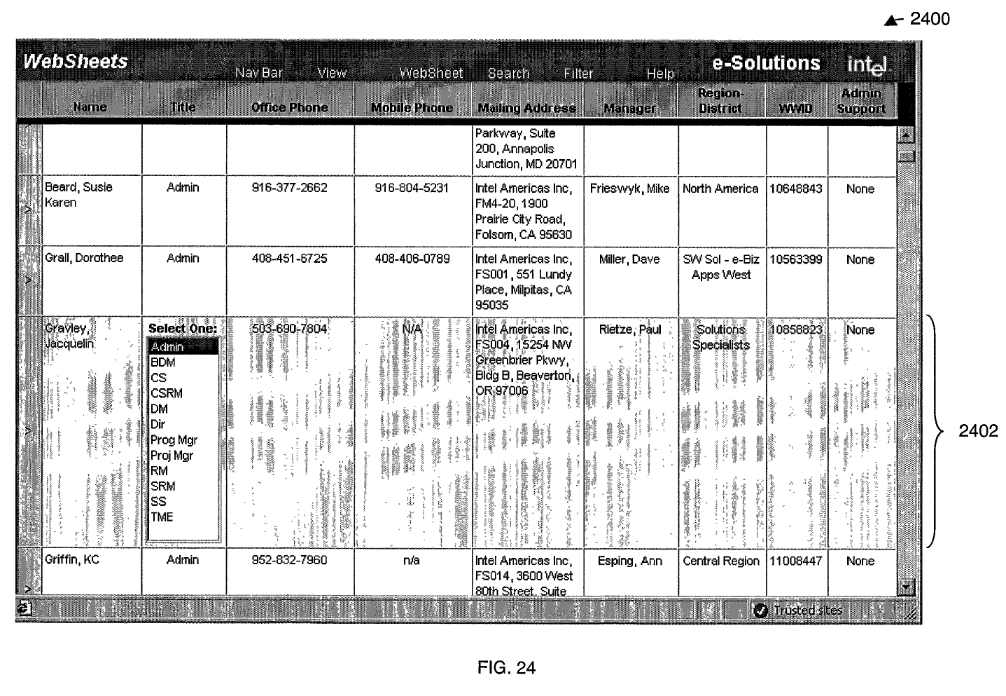

Thus in FIG. 24 is illustrated one embodiment of the present invention where the pick list was as defined in FIG. 23. Here, at 2402 the user has clicked on the Title where a Select One: pick list has been displayed with the possible picks.

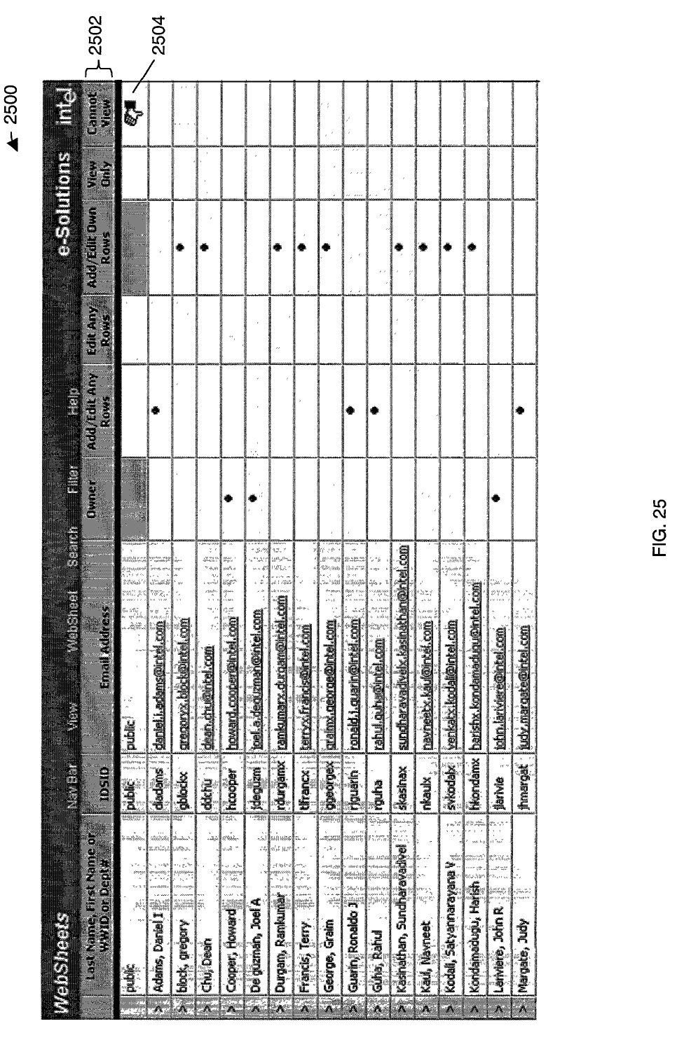

FIG. 25 illustrates one embodiment 2500 of the present invention where a security entry page is illustrated. On this page the names of persons who have permission to use a websheet are entered into the leftmost column under the column heading at 25-2 of Last Name, First Name or WWID or Dept#. Websheets supports auto-lookup, so for example, in the last row after entering Margate, Judy, the auto lookup finds and enters automatically into the IDSID filed the value of jhmargat, and into the Email Address column the value of judy.margate@intel.com. Moving from higher permission to lower permission at 2502 is Owner, Add/Edit Any Row, Edit Any Rows, Add/Edit Own Rows, View Only, and Cannot View. The level of permission for each user is indicated by a dot entry or other symbol. A higher level allows access to all lower levels. For example, an Owner has the highest permission and may add/edit anything including editing the websheet design itself. In FIG. 25, the user Francis, Terry may only Add/Edit Own Rows and view. On the other hand, a member of the public (first row) may not even view the websheet. At 2504 this is indicated by a graphic thumbs down. This graphic is the type discussed above in FIG. 19 under the column at 1902 labeled Image. This permission page entry also may appear in other websheets, for example, in FIG. 15 at 1506 are the Your Permissions, and the Public Permissions related to each Websheet Name.

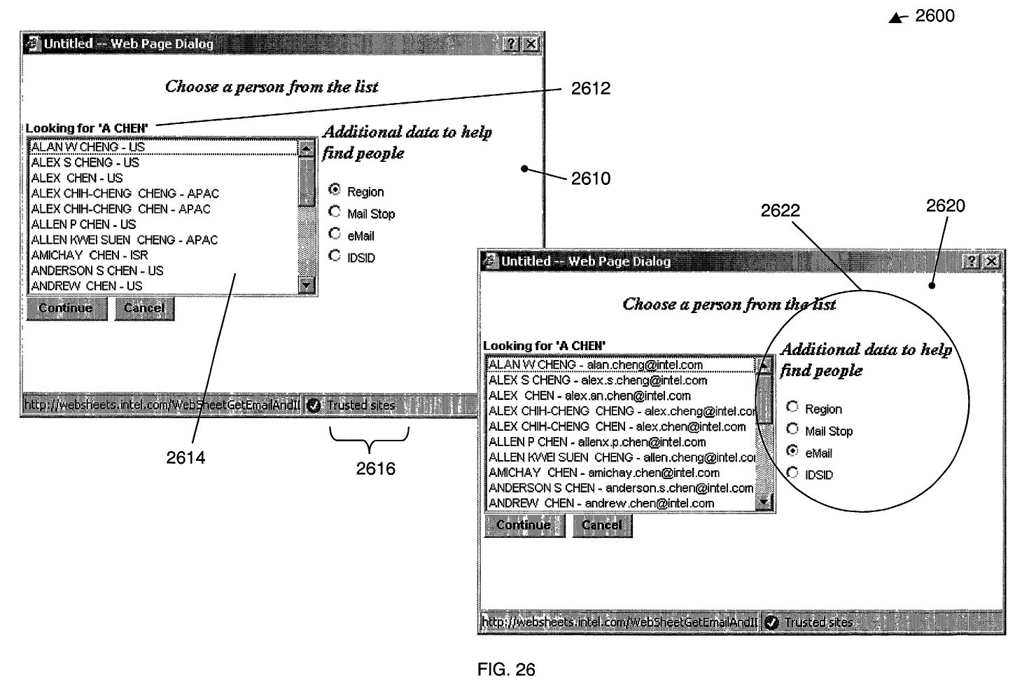

Websheets also support popup dialog boxes. For example, in FIG. 25 if a name is entered into the security page that is not unique a dialog box may appear to let the user choose the correct person. FIG. 26 illustrates one embodiment 2600 of the present invention where a dialog box is illustrated. At 2610 is a dialog box. Here the box indicates that the person it is looking for is A. CHEN 2612. At 2614 is a scroll box with entries and at 2616 is a radio button to assist in finding people. At 2620 the radio selection 2622 has been changed to provide the eMail of the persons. This may assist in locating the correct person.

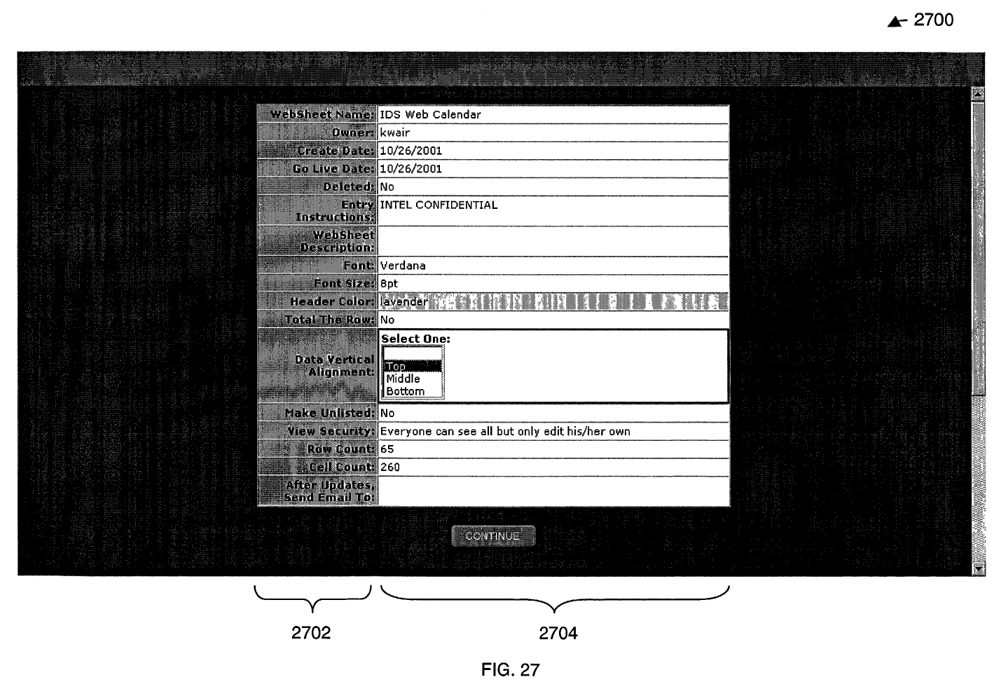

FIG. 27 illustrates one embodiment 2700 of the present invention where the editing of a websheet's properties is illustrated. At column 2702 are listed some websheet attributes and at 2704 are some sample entries. As illustrated in FIG. 27, the WebSheet Name is IDS Web Calendar, the Font is Verdana, and the Font Size is 8 pt. Websheets support update notification, where after an update an email may automatically be sent to appropriate persons, departments, etc. indicating that a change has taken place. This may be useful for time critical tracking of rapidly changing events. At 2702 such support is provided by the row labeled After Update, Send Email To:. Also supported is the vertical alignment of data at top, middle or bottom as shown in the row labeled Data Vertical Alignment:.

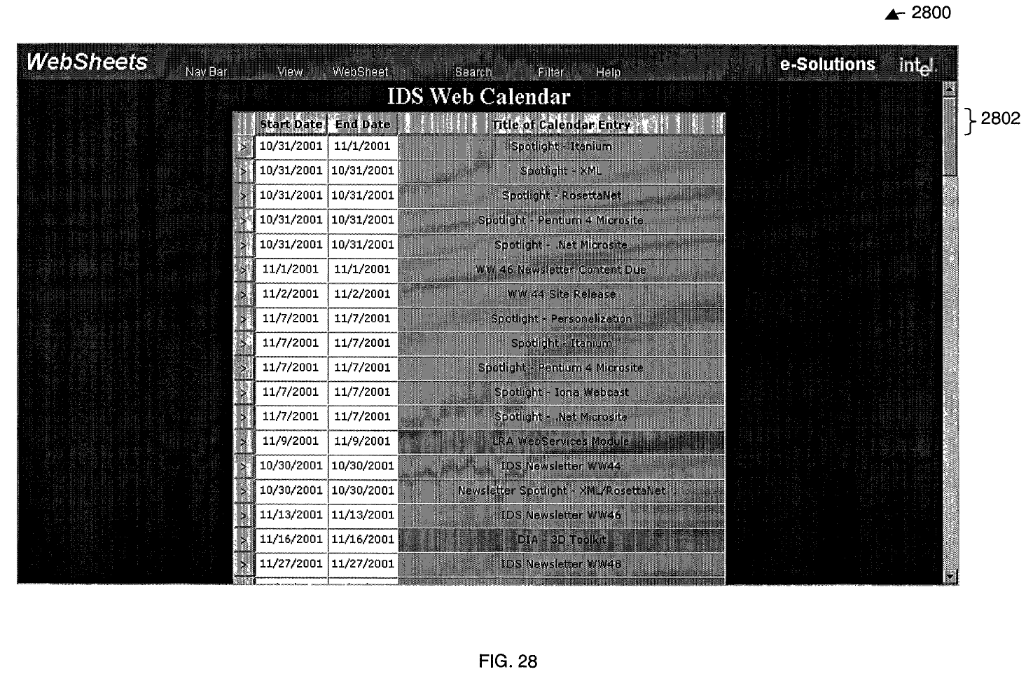

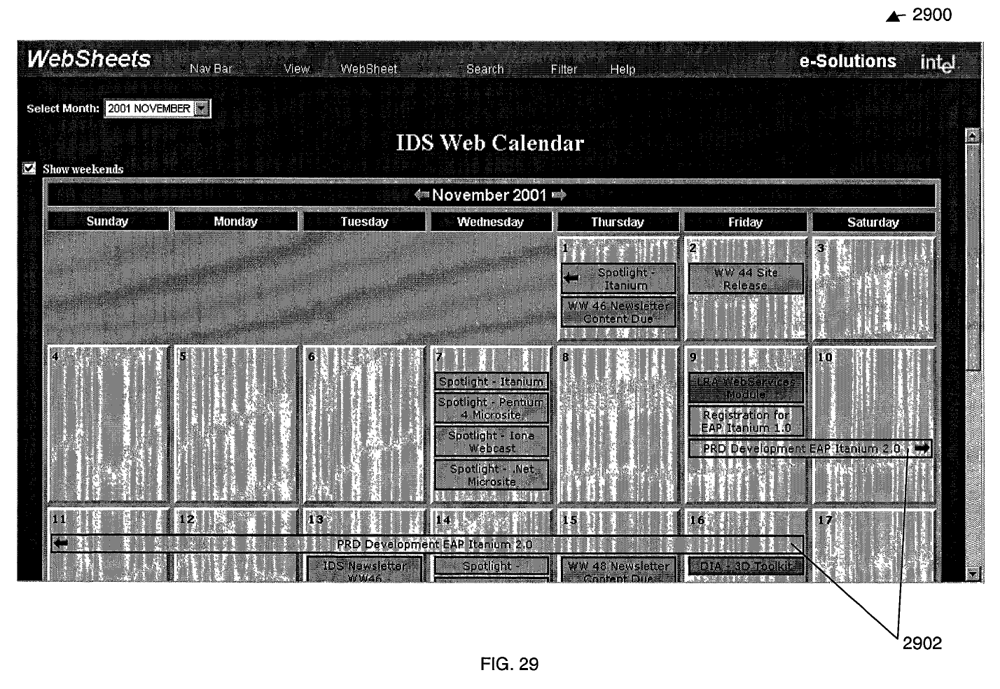

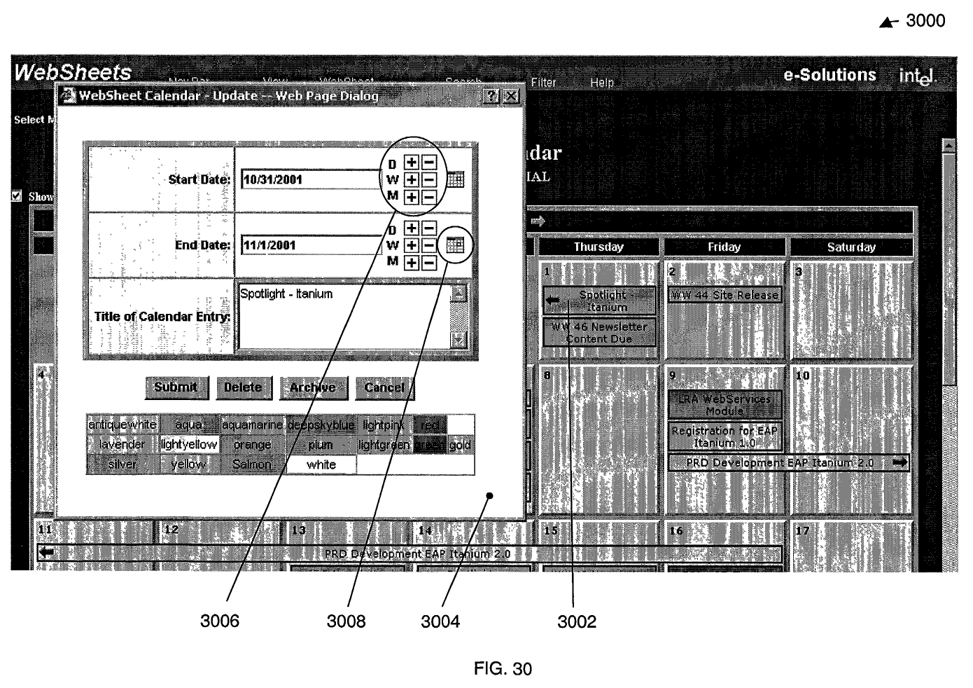

FIG. 28, FIG. 29, and FIG. 30 all illustrate various embodiments (2800, 2900, and 3000 respectively) of the present invention where the websheet has calendar functions. In FIG. 28 at 2802 are calendar entry columns titled Start Date, End Date, and Title of Calendar Entry. Data may be entered, for example, as illustrated in 2800. FIG. 29 illustrates what may be displayed to a user. Date entries may span a range of days. Illustrated at 2902 is a date for PRD Development EAP Itanium 2.0 which goes from Nov. 9, 2001 to Nov. 16, 2001 as denoted by the horizontal bar on the calendar. In FIG. 30 the user has clicked on the entry at 3002 and an update dialog window 3004 has opened. Note that the user may enter and/or adjust the start and end date as well as the title of the entry. At 3006 are increment and decrement adjustments by day (D), week (W), or month (M). Also provided is a calendar button 3008 for choosing a date on a calendar.

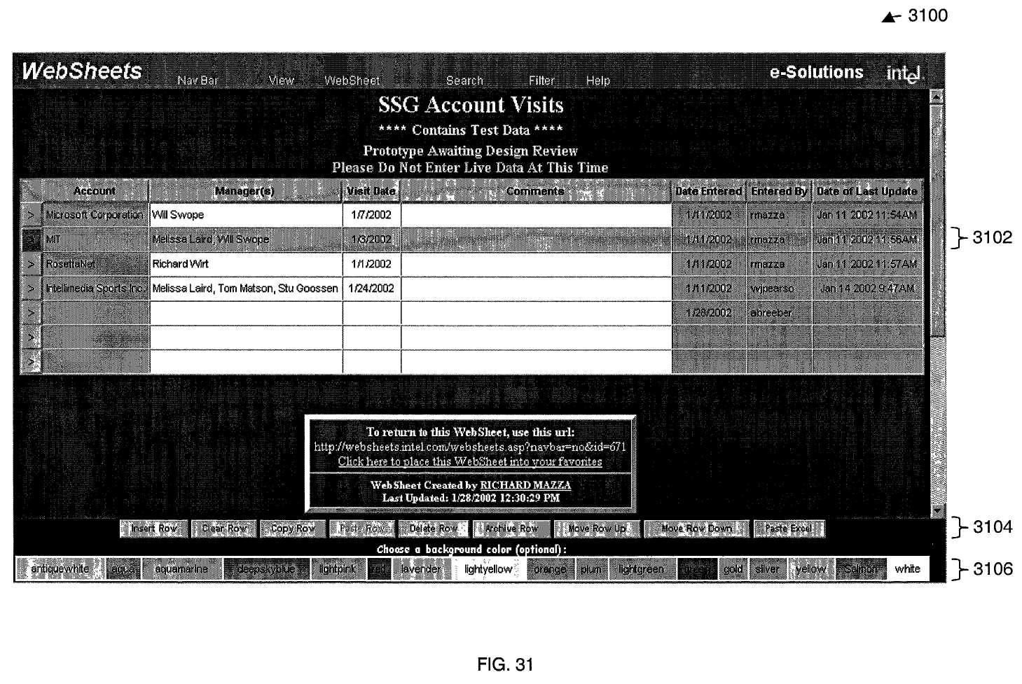

FIG. 31 illustrates an embodiment 3100 of the present invention where a row has been selected during data entry. In this illustration, the user has clicked on the row 3102. As a result of the selection of row 3102, help information and operations have appeared at 3104 and 3106. At 3104 are operations that are allowed for the selected (3102) row. Operations may include Insert Row, Clear Row, Copy Row, Paste Row (grayed out in this illustration), Delete Row, Archive Row, Move Row Up, Move Row Down, and Paste Excel. At 3106 is the option to choose a background color. Thus, when a user clicks on a row selection, buttons and a color palette appear at the bottom.

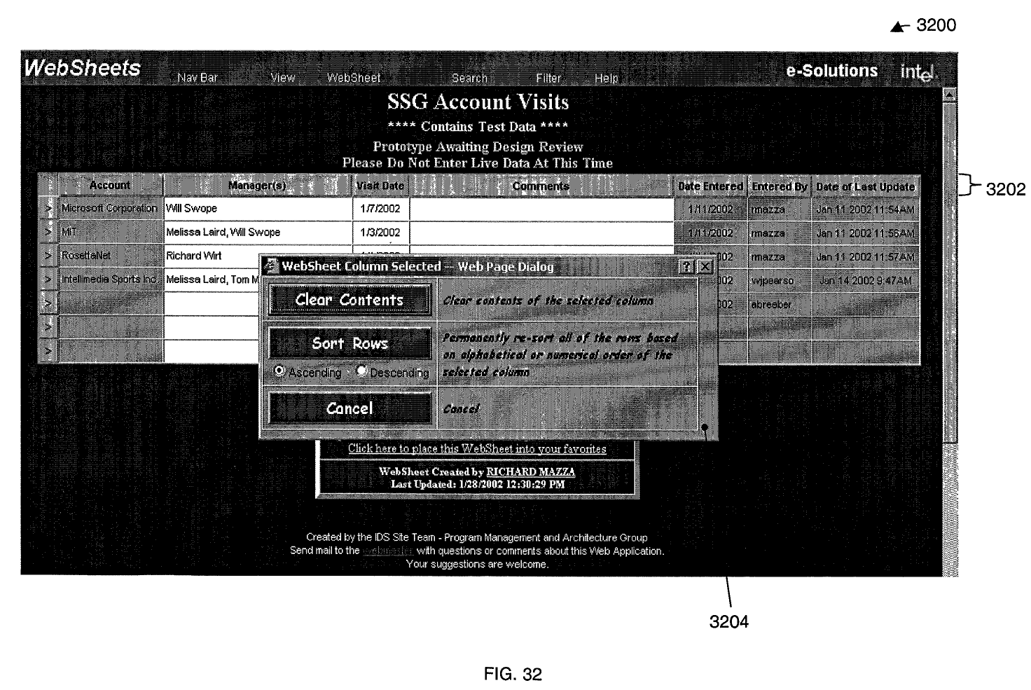

FIG. 32 illustrates an embodiment 3200 of the present invention where a column has been selected during data entry. In this illustration, the user has clicked on the column Account in the row 3202. As a result of the selection of the Account column, a dialog box 3204 has appeared. Here, operations allowed on that column are described. For example, in this illustration, the column may be cleared of contents, the rows may be sorted either ascending or descending, or the user may cancel the operation.

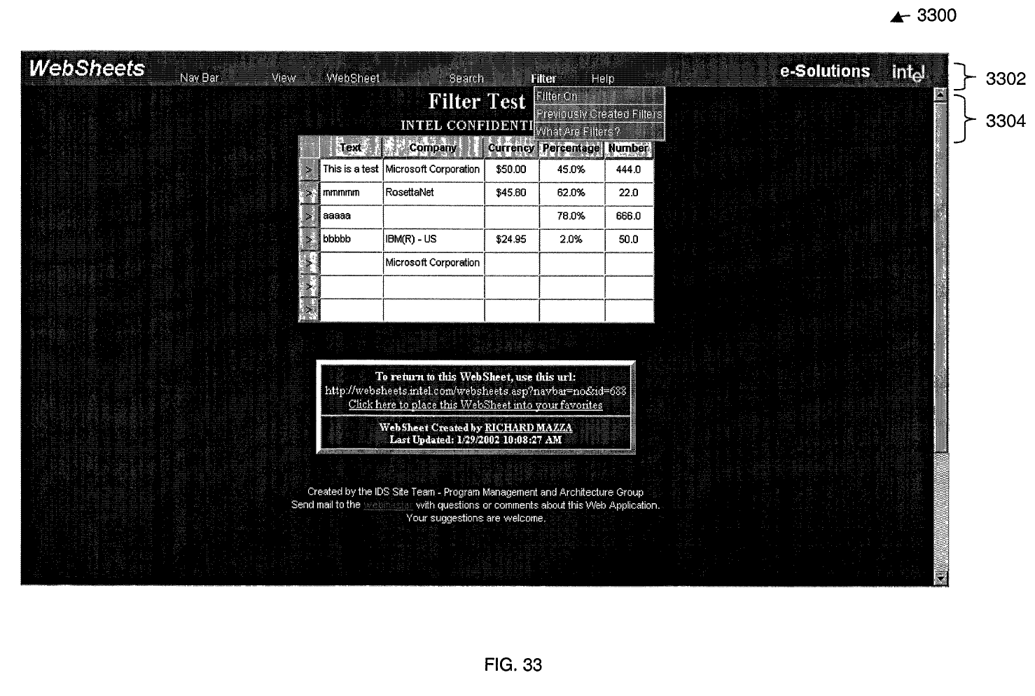

FIG. 33 illustrates an embodiment 3300 of the present invention where the user has selected Filter. At the top of websheets may be a menu bar with various options 3302. In this illustration, the user has clicked on the Filter item and has been presented with three options 3304 in a menu. One option is to Filter On a criteria to be entered. Another is to use a Previously Created Filter. And the last option is to access help by selecting What Are Filters?.

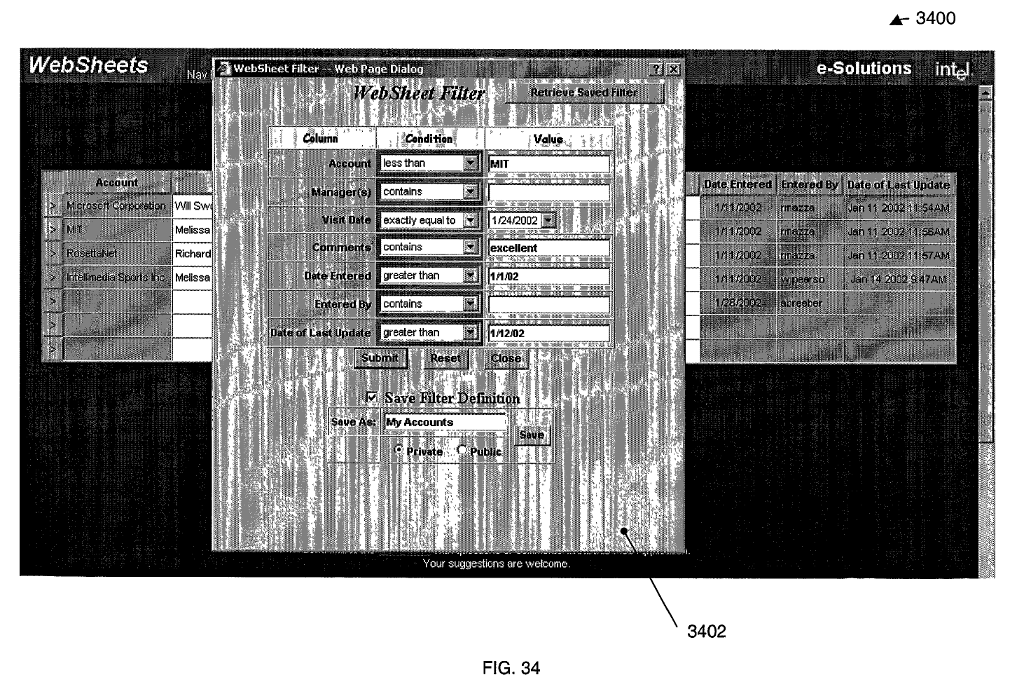

FIG. 34 illustrates an embodiment 3400 of the present invention where the user has selected to enter filter criteria. The dialog box 3402 allows the user to retrieve a saved filter, enter new criteria, and also save a new filter setting. As may be seen each column may have a condition and a value. Thus, for example, in the illustration in FIG. 34, the user has set that the column Comments has the condition contains and the value is the word excellent. Note that each of the conditions is a pull down box.

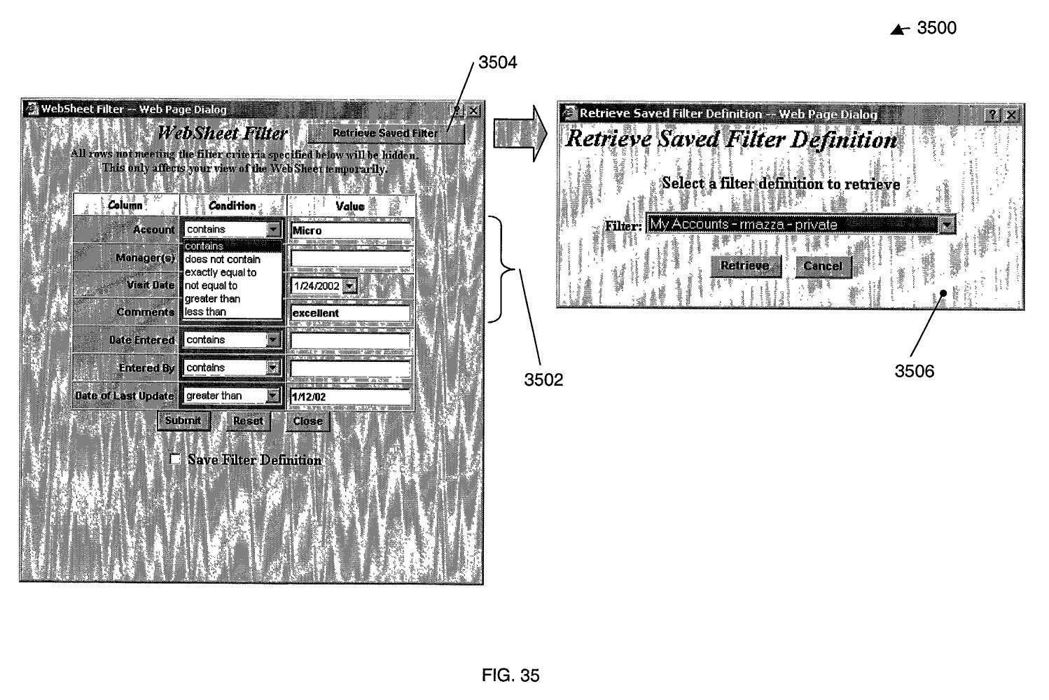

FIG. 35 illustrates an embodiment 3500 of the present invention where a pull down filter condition box is shown 3502. The pull down box 3502, as illustrated, has the following options for the column Account: contains, does not contain, exactly equal to, not equal to, greater than, and less than. Pull down boxes for other columns may have different options, for example, a Date Entered drop down (also called a pull down) box may have calendar information options. If the user decides to retrieve a saved filter by pressing the Retrieve Saved Filter button 3504, then the dialog box 3506 opens allowing the user to retrieve a filter. Note also that the Filter at 3506 also has a pull down box capability.

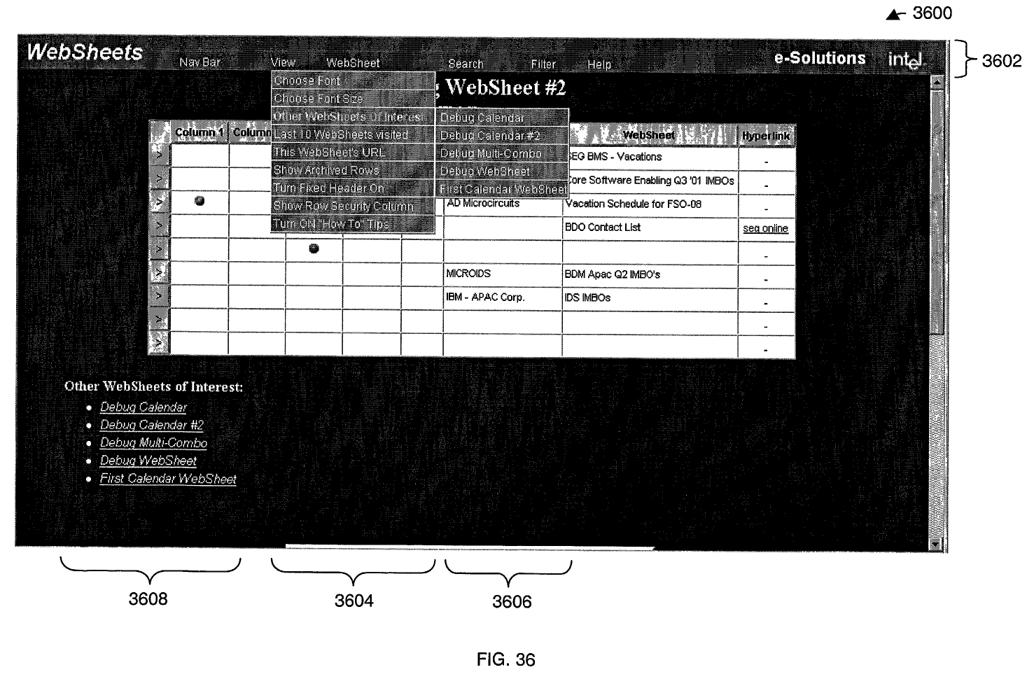

FIG. 36 illustrates an embodiment 3600 of the present invention where the user has selected to view other websheets of interest. At the top of websheets may be various options 3602. In this illustration, the user has clicked on the View option and has been presented with options 3604 of which the user selected Other WebSheets Of Interest, which resulted in a display 3606. There was also the display at 3608 of other websheets which was present, for example, when the user selected View at 3602. The user may select any of these other websheets (3606 or via 3608) to view. Thus there has been provided, in this illustration, two ways to get to the list of other websheets of interest.

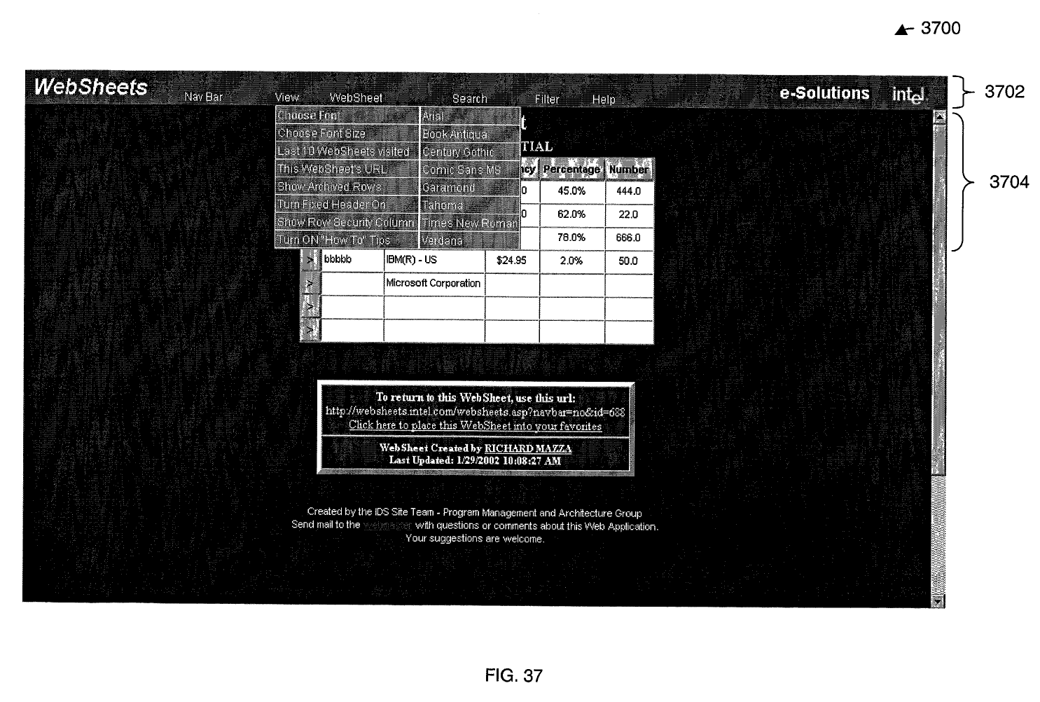

FIG. 37 illustrates an embodiment 3700 of the present invention where the user has selected to view and choose a font. At the top of websheets may be various options 3702. In this illustration, the user has clicked on the View option and has been presented with options 3704 of which the user selected Choose Font.

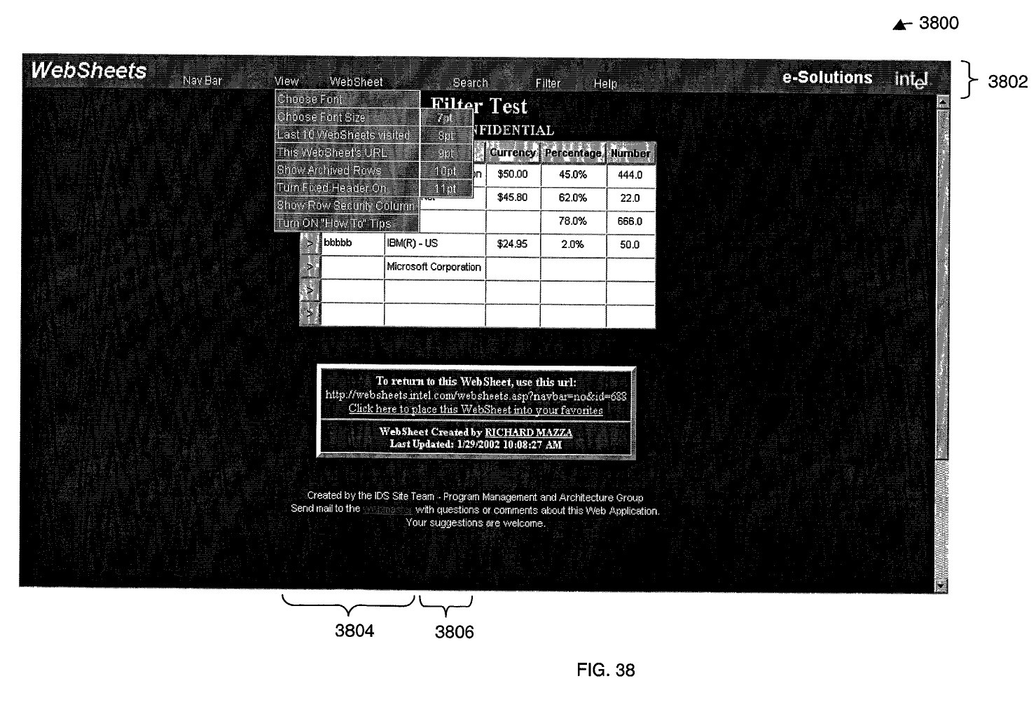

FIG. 38 illustrates an embodiment 3800 of the present invention where the user has selected to view and choose a font size. At the top of websheets may be various options 3802. In this illustration, the user has clicked on the View option and has been presented with options 3804 of which the user selected Choose Font Size, which resulted in another display 3806 of available font sizes (7, 8, 9, 10, and 11 point).

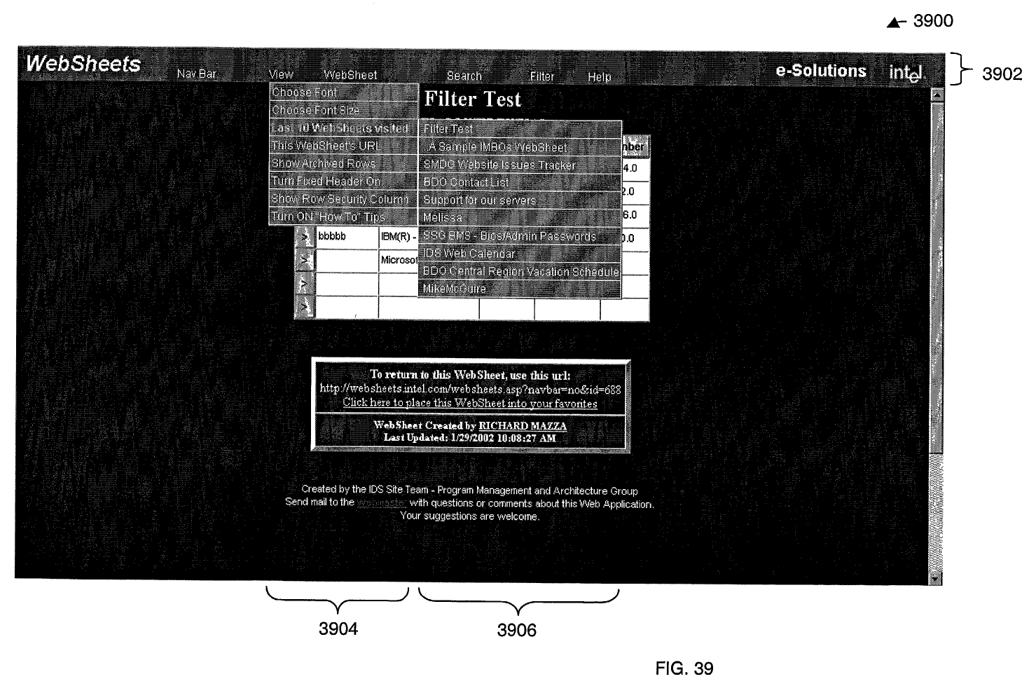

FIG. 39 illustrates an embodiment 3900 of the present invention where the user has selected to view the last ten websheets visited. At the top of websheets may be various options 3902. In this illustration, the user has clicked on the View option and has been presented with options 3904 of which the user selected Last 10 WebSheets visited, which resulted in another display 3906 which has a list of the last ten websheets that this user visited.

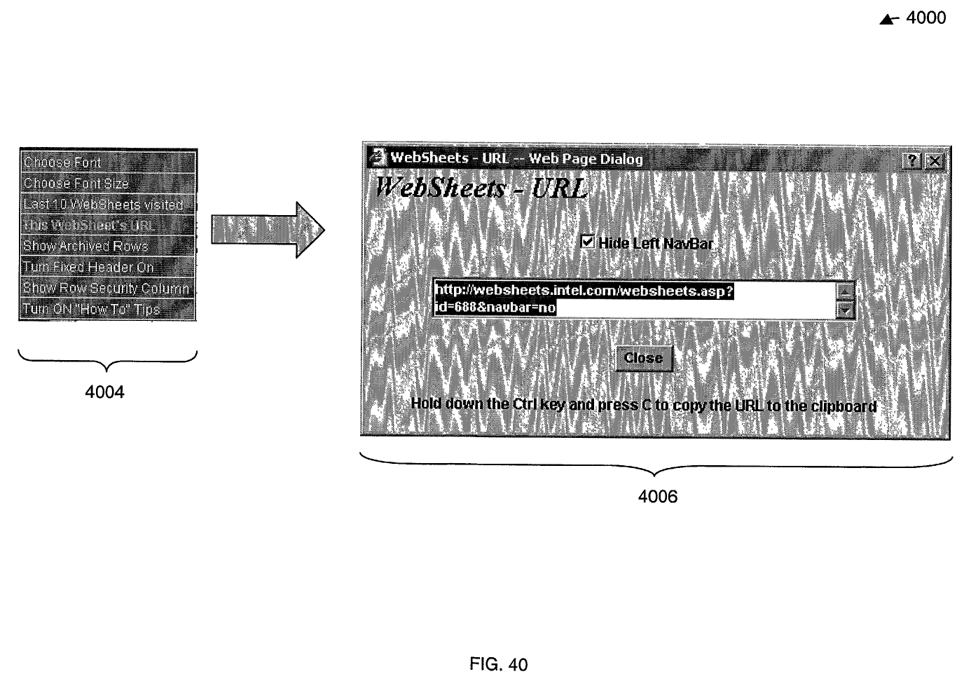

FIG. 40 illustrates an embodiment 4000 of the present invention where the user has selected to view the This WebSheet's URL. At the top of websheets may be various options as shown in FIG. 39 at 3902. If the user in FIG. 39 clicked on the View option, they would be presented with options 3904, or as shown in FIG. 40 at 4004. If the user then selected This WebSheet's URL, then another display 4006 would show information related to the current websheet's universal resource locator (URL).

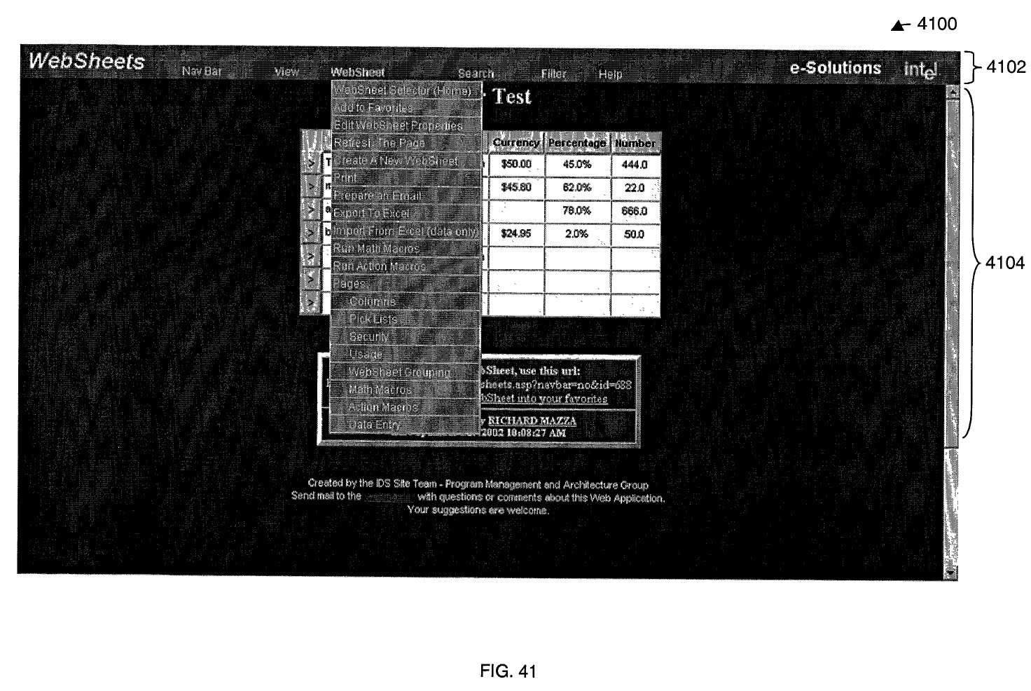

FIG. 41 illustrates an embodiment 4100 of the present invention where the user has selected the WebSheet option. At the top of websheets may be various options 4102. In this illustration, the user has clicked on the WebSheet option and has been presented with a menu 4104 from which the user may select.

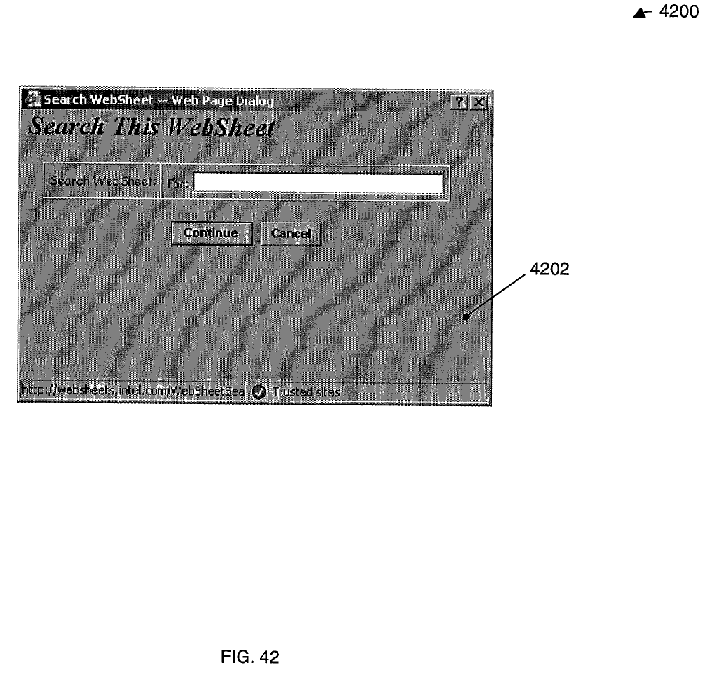

FIG. 42 illustrates an embodiment 4200 of the present invention where the user has selected Search on the menu bar. At the top of websheets may be various options displayed as a menu bar (for example, as shown in FIG. 39 at 3902). If the user in FIG. 39 clicked on the Search menu bar item, they would be presented with a search dialog box as illustrated in FIG. 42 ate 4202. Here, the user may enter a search term for the websheet or cancel out of this operation.

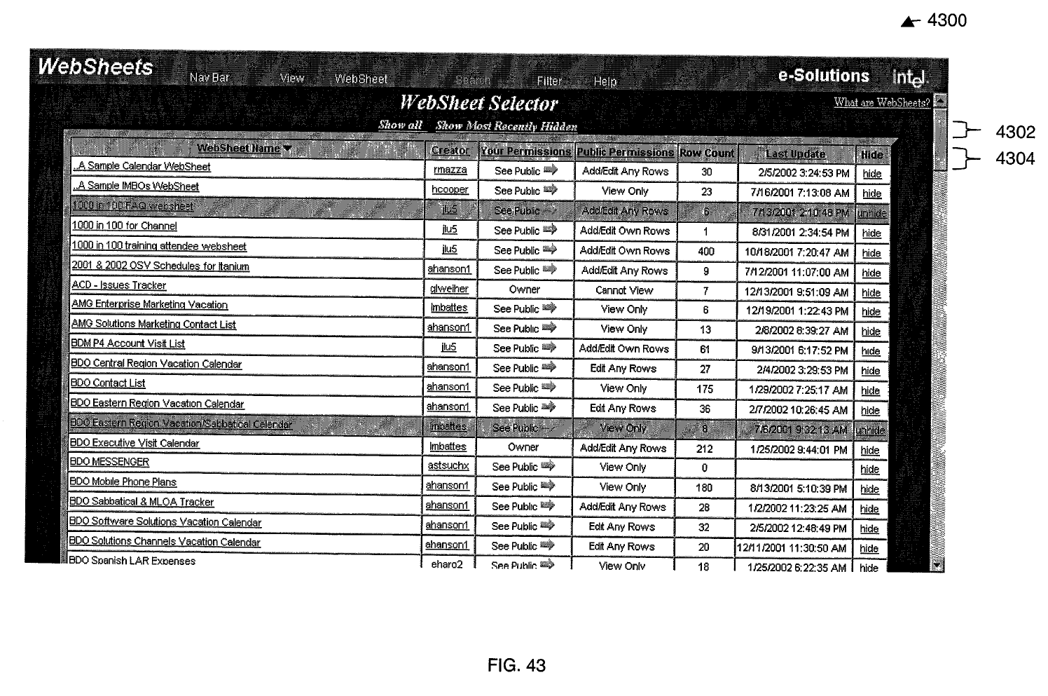

FIG. 43 illustrates one embodiment 4300 of the present invention where a websheet selector is illustrated with hidden sheets. At 4302 are several options for viewing websheets in existence, they are Show all, and Show Most Recently Hidden. At 4304 is a column labeled Hide. This column may be used to hide or unhide websheets of interest. The column Hide allows the user by clicking on the respective hide link in any row to hide that websheet from the WebSheet Selector view. To unhide, the selections at 4302 (Show all, and Show Most Recently Hidden) may be used.

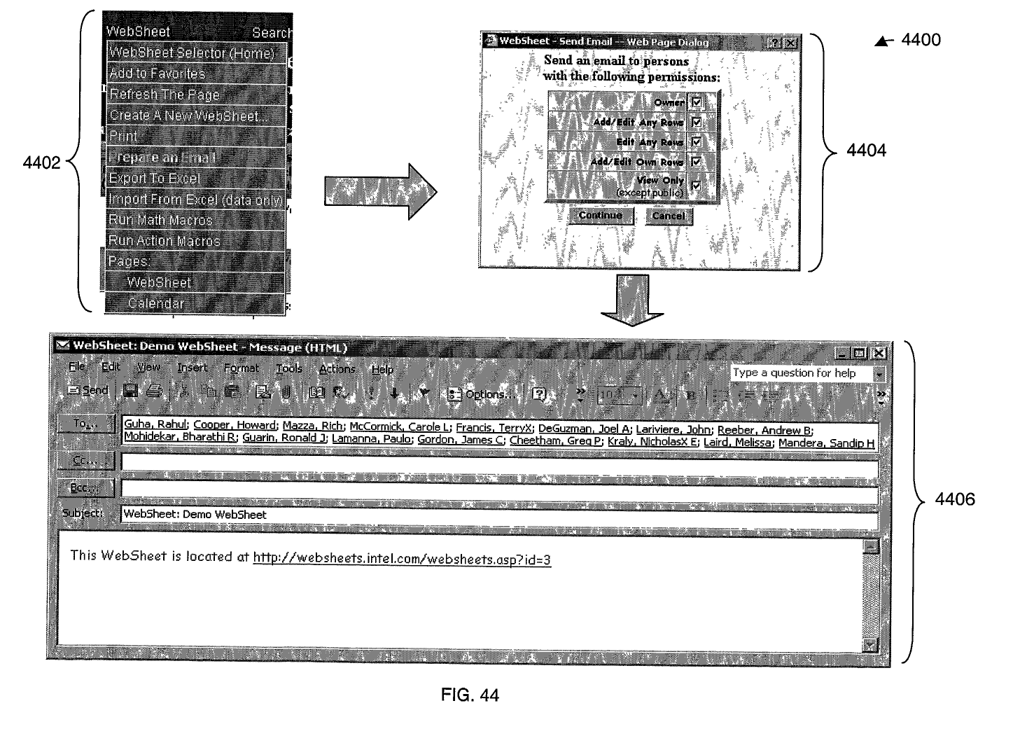

FIG. 44 illustrates one embodiment 4400 of the present invention where emailing is illustrated. At 4402 the user has selected from the menu bar (such as, for example, in FIG. 41 at 4102) the WebSheet menu item. At 4402 is the menu and the user has selected Prepare an Email. Dialog box 4404 then appears allowing the user to select the criteria for sending an email. When the user continues then an email 4406 is generated. In this way, the selected email recipients are informed about the websheet.

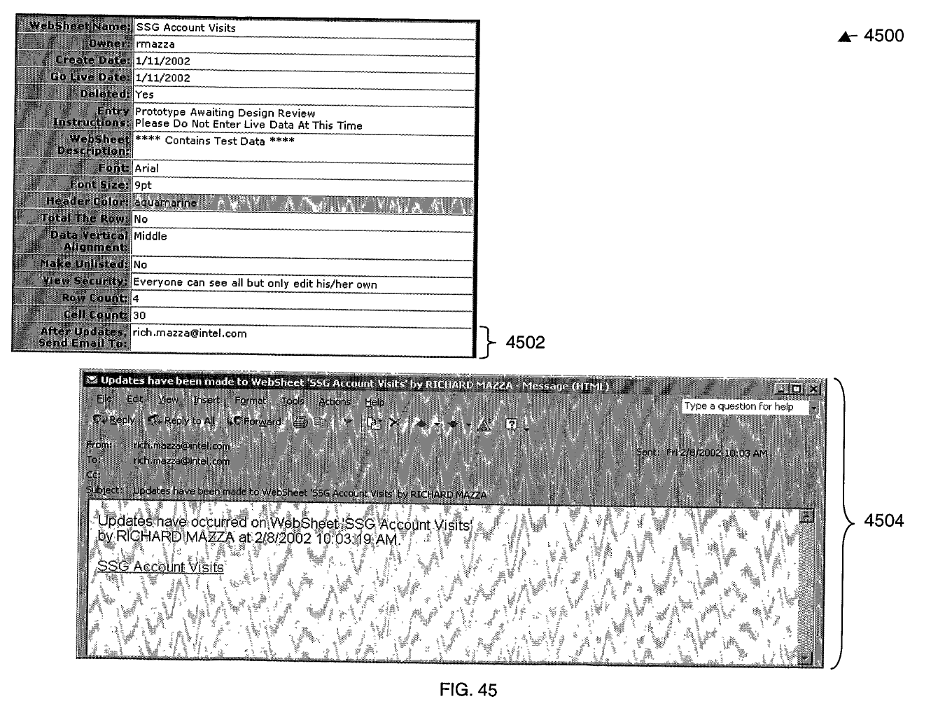

FIG. 45 illustrates one embodiment 4500 of the present invention where automatic emailing is illustrated. As previously mentioned, an email may be automatically generated and sent when a websheet is updated. At 4502 an owner of a websheet has entered an email address of a person (rich.mazza@intel.com) to notify after an update to the websheet. At 4504 the email that results if the websheet is updated. In this way, email recipients are informed of a change to the websheet.

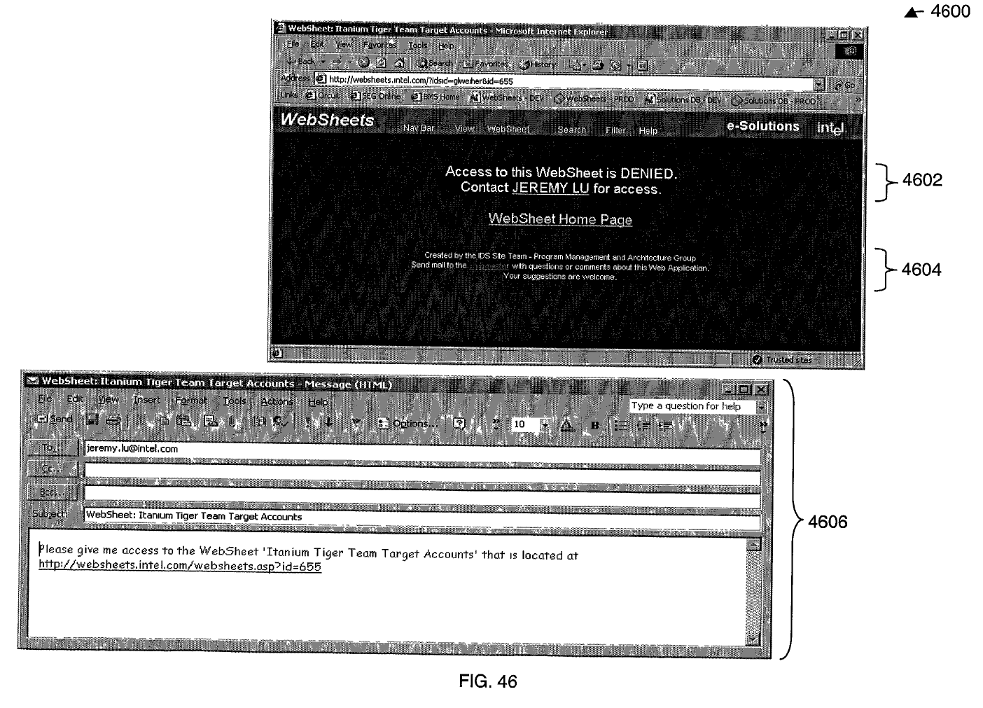

FIG. 46 illustrates one embodiment 4600 of the present invention where emailing for a denied websheet is illustrated. A user, as detailed above, may be denied access to a websheet. There may be a need to contact someone to change this permission. For example, a new employee may need access to a websheet. A user denied access may receive a message such as that illustrated at 4602. At 4604 is an email link which if selected will open up an email message dialog 4606 where the requesting user may type a message. In this way, a denied user may easily request access to a websheet.

Thus, various embodiments illustrating websheets have been described.

Referring back to FIG. 1, FIG. 1 illustrates a network environment 100 in which the techniques described may be applied. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to essentially any type of communicating means or device whether local or remote, such as a LAN, a WAN, a system bus, etc.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, a Cathode Ray Tube (CRT), Liquid Crystal Display (LCD), a projection system, Television (TV), etc. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those skilled in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention can be implemented by an apparatus for performing the operations herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Thus, websheets have been described.

What is claimed is:

1. A method comprising:
clicking on a cell to activate an editing mode for editing the cell's contents;
changing the cell's contents or possibly leaving the cell's contents unchanged;
closing the editing mode; and
displaying the unchanged cell's contents in the cell if the cell contents are unchanged, otherwise displaying the changed cell contents.

2. The method of claim 1 wherein the cell is an hyper-text markup language (HTML) table.

3. The method of claim 2 wherein displaying the contents in the HTML table does not require a refresh operation.

4. The method of claim 1 wherein the editing mode has data entry mechanisms selected from the group consisting of a text box, a file selector, a pick list, a universal resource locator (URL), and a user defined entry.

5. The method of claim 4 wherein the pick list has selection capability selected from the group consisting of single pick, multiple pick, combo pick, and multi-combo pick.

6. The method of claim 1 wherein the cell's contents has data selected from the group consisting of a number, a percentage, text, currency, date, yes/no, a partial date, a hyperlink, date of last update, a toggle, a file, and extensible markup language (XML) information.

7. The method of claim 1 further comprising:
adding an entry to a historical file of the cell's prior contents if the cell's contents are changed.

8. The method of claim 8 wherein a cell's prior contents may be restored to the cell by selecting the cell's prior historical file entry.

9. The method of claim 1 wherein activating the edit mode does not require clicking on an edit button.

10. The method of claim 9 wherein clicking on an empty cell opens a text box.

11. The method of claim 1 wherein activating the editing mode comprises inserting HTML code.

12. The method of claim 11 wherein the HTML code is executed on a client system.

13. The method of claim 1 wherein closing the editing mode comprises removing previously inserted HTML code.

14. A method for in-place editing of a cell in a HTML table comprising:
inserting HTML code for editing any contents that may be in the cell;
receiving user inputs for editing the cell contents;
generating a result by executing the HTML code using the received user inputs;
removing the HTML code; and
displaying the result in the cell.

15. The method of claim 14 wherein the HTML code is inserted and removed from the cell.

16. The method of claim 14 further comprising generating a historical cell record if the cell contents have changed.

17. The method of claim 14, wherein the inserted HTML code is based upon contents in another cell.

18. The method of claim 17 wherein the inserted HTML code is run locally on each client.

19. A processing system comprising a processor, which when executing a set of instructions performs the method of claim 14.

20. A machine-readable medium having stored thereon instructions, which when executed performs the method of claim 14.

21. An apparatus comprising:
means for selecting a cell;
means for inserting HTML code in a cell;
means for receiving user inputs;
means for executing the HTML code with the user inputs and generating a result;
means for removing the HTML code in the cell; and
means for displaying the result in the cell.

22. The apparatus of claim 21 further comprising means for maintaining a historical record of cell results.

23. A machine-readable medium having stored thereon information representing the apparatus of claim 21.

24. A system comprising a processor, which when executing a set of instructions, performs the following:
inputs a user cell selection;
inserts HTML code to allow editing of the cell selection;
inputs user editing commands;
executes the HTML code with the user editing commands, generating a result;
removes the HTML code; and
stores the result in the cell selection.

25. The method of system of claim 24 further comprising maintaining a historical record of previous cell selection contents.

26. The system of claim 24 further comprising transferring a payment and/or a credit.

27. A method for in-place editing of a cell, the method comprising:
inputting a user click selecting the cell for editing;
inserting editing code into the cell;
receiving user editing instructions;
executing the code using the user editing instructions generating a result;
removing the editing code from the cell; and
inserting the result into the cell.

28. The method of claim 27 wherein the cell is an HTML table entry, and the editing code is HTML code located on a client.

29. The method of claim 27 wherein the editing code is based upon contents in another cell.

30. The method of claim 27 wherein the inserted editing code has as a default value the cell contents at the time the code is inserted into the cell.

31. A grid based graphical user interface editing method comprising:
picking a cell by clicking on the cell;
selecting an entry from the group consisting of a blank, an editable text box, a pick one, a single pick list, a multi-pick list, a combo pick list, a multi-combo pick list, a hyperlink, a toggle, a graphic, a date, a partial date, a currency, a number, an auto-increment number, an auto-increment letter, and a file; and
displaying the entry.

32. The method of claim 31 wherein any data present in the cell will be highlighted in the entry selection.

33. The method of claim 32 wherein an existing highlighted entry may be de-selected by clicking on the entry.

34. The method of claim 31 wherein the entry selection is based upon contents in another cell.

35. The method of claim 34 wherein the entry selection is column based.

36. The method of claim 35 wherein said another cell is located at the top or bottom of the grid.

37. The method of claim 31 further comprising uploading the file contents into the cell.

38. A processing system comprising a processor, which when executing a set of instructions performs the method of claim 31.

39. A machine-readable medium having stored thereon instructions, which when executed performs the method of claim 31.

40. A method for data presentation and editing in a grid format comprising;
providing a plurality of columns;
providing a plurality of rows;
storing data at each intersection of a row and a column, hereinafter called a cell; and
providing in-place editing of cell contents.

41. The method of claim 40 further comprising maintaining a retrievable historical record for cells.

42. The method of claim 40 further comprising providing security permissions to users for editing and viewing the cells.

43. The method of claim 40 wherein selecting a top-most or a bottom-most column cell allows a user with appropriate security permissions to do column operations selected from the group consisting of delete, change data type, change permissions, insert, copy, edit, rename, and replace.

44. The method of claim 40 wherein selecting a left-most or a right-most row cell allows a user with appropriate security permissions to do row operations selected from the group consisting of delete, insert, copy, edit, and replace.

45. The method of claim 40 wherein a user with appropriate security permissions may send to all users with selected security permissions an email.

46. The method of claim 45 wherein the email is automatically generated informing all email recipients that a said in-place editing has changed a cell's contents.

47. The method of claim 40 wherein duplicate data may be hidden.

48. The method of claim 40 wherein calendar data has a graphical representation of a bar extending from a start date to an end date.

49. The method of claim 40 further comprising displaying rows based upon column based filtering.

50. The method of claim 49 wherein the column based filtering is based upon multiple columns.

51. The method of claim 49 wherein the column filtering criteria are selected from the group consisting of contains, does not contain, exactly equal to, not equal to, greater than, less than, begins with, ends with, and sounds like.

52. A machine-readable medium having stored thereon instructions, which when executed performs the method of claim 40.

53. A processing system comprising a processor, which when executing a set of instructions performs the method of claim 40.

54. A machine-readable medium having stored thereon information representing the system of claim 53.

55. The method of claim 40 further comprising transferring a payment and/or a credit.

56. An apparatus comprising:
a user interface having a plurality of inputs and a plurality outputs, a first input coupled to receive a user selection of a cell, a second input coupled to receive user editing operations for said selected cell, a first output to transmit a cell selection, a second output to transmit user editing operations;
an execution engine having a plurality of inputs and a plurality of outputs, a first input coupled to receive the user interface first output, a second input coupled to receive the user interface second output, a first output to transmit HTML code, a third input to receive the HTML code, and a second output to transmit a result; and
a display having an input and an output, the input coupled to receive the execution engine second output, and the output to transmit to a user contents of said selected cell.

57. The apparatus of claim 56 further comprising a history engine for maintaining a historical record of previous said selected cell results.

58. The apparatus of claim 56 wherein the result has the execution engine first output HTML code removed.
